(19) United States
(12) Patent Application Publication
(10) Pub. No.: US 2026/0225396 A1
(43) Pub. Date: Aug. 6, 2026

(54) DECORATIVE SHEET SET, DECORATIVE STRUCTURE, METHOD FOR CONSTRUCTING DECORATIVE STRUCTURE, AND METHOD FOR PRODUCING DECORATIVE SHEET

(71) Applicant: KMEW Co., Ltd., Osaka (JP)

(72) Inventors: Chikako OTA, Nara (JP); Masafumi HORI, Nara (JP)

(21) Appl. No.: 19/152,002

(22) PCT Filed: Jan. 29, 2024
(86) PCT No.: PCT/JP2024/002686

§ 371 Date: Jul. 30, 2025

(30) Foreign Application Priority Data
Jan. 31, 2023 (JP) 2023-013248
Oct. 17, 2023 (JP) 2023-178894

(51) Int. Cl. B44C 1/00; B44F 5/00

(52) U.S. Cl. CPC B44C 1/00; B44F 5/00

(57) ABSTRACT

A decorative sheet set includes one each of decorative sheets having surfaces provided with appearance designs different from one another to form a decorative structure which makes a harmonious impression. A variation in the appearance designs of the decorative sheets is within a prescribed range.

### RELATED APPLICATIONS

The present application is a National Phase of International Application Number PCT/JP2024/002686, filed on Jan. 29, 2024, which claims priority based on Japanese application No. 2023-013248, filed Jan. 31, 2023, and Japanese application No. 2023-178894, filed Oct. 17, 2023.

### TECHNICAL FIELD

The present disclosure relates to decorative sheet sets, decorative structures, methods for constructing the decorative structures, decorative structures, and methods for producing decorative sheets. More specifically, the present disclosure relates to: a decorative sheet set including a plurality of types of decorative sheets; a decorative structure including a plurality of decorative sheets; a method for constructing a decorative structure; a method for producing a decorative structure which is to be installed in, for example, a building; a method for producing a decorative material set suitable for fabricating the decorative structure; and a method for producing a decorative material configured to be included in the decorative material set.

### BACKGROUND ART

A recently increasing variations in design leads to a demand for increased variations in design for wall surfaces of exterior walls, roofs, and the like of constructions. Patent Literature 1 describes a roofing structure. The roofing structure is a structure formed by installing a plurality of roofing materials on a backing of a roof and includes, as the roofing materials, two or more types of roofing materials distinguishable based on the surface colors thereof are employed, wherein a color difference between the roofing materials of one color with the largest total exposed area on the roof and the roofing materials of another color is in a range of 3 to 7. Structures, such as this structure, employing roofing materials of different colors within a predetermined color difference range to improve a design property while maintaining a natural impression have been proposed.

### CITATION LIST

### Patent Literature

Patent Literature 1: JP 2008-208542 A

### SUMMARY OF INVENTION

In order to install decorative sheets of different colors such that the decorative sheets appear natural to the human eye, disposition locations of the decorative sheets according to the colors of the decorative sheets have to be taken into consideration. Moreover, a change in ratio of the colors of the decorative sheets may significantly change the impression of a wall surface composed of the decorative sheets. Therefore, in the case of traditional decorative sheets, locations of the decorative sheets have to be determined prior to the installation, or a craftsperson at an installation site has to install the decorative sheets while checking an overall balance of the wall surface. Therefore, there is a demand for a set of decorative sheets which are employed in multiple types to improve the design property and which appear natural, regardless of who installs the decorative sheets.

In view of the foregoing, it is an object of the present disclosure to provide a decorative sheet set of decorative sheets, the decorative sheet set being configured to form a decorative structure which makes an impression of reduced incongruity even when the decorative sheets are randomly installed.

It is another object of the present disclosure to provide: a decorative structure which is configured to be formed by using the decorative sheet set and which makes an impression of reduced incongruity; and a method for constructing the decorative structure.

It is still another object of the present disclosure to provide: a decorative structure configured to reduce unnaturalness of the appearance of a decorative surface when the decorative surface has a plurality of patterns arranged in one direction; a decorative sheet set suitable for fabricating the decorative structure; and a method for producing a decorative sheet configured to be included in the decorative sheet set.

A decorative sheet set according to an aspect of the present disclosure includes a plurality of decorative sheets, the plurality of decorative sheets have appearance designs different from each other, and a variation in the appearance designs between the plurality of decorative sheets is within a predetermined range.

A decorative structure according to an aspect of the present disclosure is formed by using the decorative sheet set including one or more decorative sheet sets.

A method for constructing a decorative structure according to an aspect of the present disclosure is a method for constructing a decorative structure by using the decorative sheet set including one or more decorative sheet sets. The method includes a step of determining disposition locations of the plurality of decorative sheets in the one or more decorative sheet sets on an installation target surface, and a step of installing the plurality of decorative sheets on the disposition locations thus determined.

A decorative structure of an aspect of the present disclosure has a decorative surface. The decorative surface has an overall pattern which is a collection of a plurality of individual patterns arranged in one direction along the decorative surface. The plurality of individual patterns indispensably include a plurality of individual patterns having patterns different from each other and optionally include a plurality of individual patterns having patterns identical to each other. The plurality of individual patterns include characteristic patterns and non-characteristic patterns, the characteristic patterns are individual patterns having characteristic patterns, and the non-characteristic patterns are individual patterns having no characteristic pattern. An order in which the characteristic patterns and the non-characteristic patterns appear in the one direction in the decorative surface has no periodicity.

A decorative sheet set in an aspect of the present disclosure includes a plurality of decorative sheets stacked one on top of another. The plurality of decorative sheets have individual patterns, one for each of the plurality of decorative sheets, The individual patterns indispensably includes a plurality of individual patterns having patterns different from each other and optionally includes a plurality of individual patterns having patterns identical to each other. The individual patterns includes characteristic patterns and non-characteristic patterns, the characteristic patterns are individual patterns having characteristic patterns, and the non-characteristic patterns are individual patterns having no characteristic pattern. An order in which the characteristic patterns and the non-characteristic patterns appear in a direction in which the plurality of decorative sheets are stacked one on top of another has no periodicity.

A method for producing decorative sheet of an aspect of the present disclosure is a method for sequentially producing a prescribed number of decorative sheets. The decorative sheets have individual patterns, one for each of the decorative sheets. The individual patterns indispensably include a plurality of individual patterns having patterns different from each other and optionally include a plurality of individual patterns having patterns identical to each other. The individual patterns include characteristic patterns and non-characteristic patterns, the characteristic patterns are individual patterns having characteristic patterns, and the non-characteristic patterns are individual patterns having no characteristic pattern. The method includes sequentially coating base materials prepared in the prescribed number while continuously transporting the base materials to provide the base materials with the individual patterns on a one-to-one basis. In coating the base materials, an order in which the characteristic patterns and the non-characteristic patterns appear has no periodicity.

### BRIEF DESCRIPTION OF DRAWINGS

FIG. 1 is a front view of an embodiment of a decorative sheet set of the present disclosure;

FIG. 2 is a front view of the embodiment;

FIG. 3 is a front view of the embodiment;

FIG. 4 is a front view of a decorative structure of the embodiment;

FIG. 5 is a front view of a decorative sheet set as a comparison target of the embodiment;

FIG. 6 is a front view of a decorative sheet set as a comparison target of the embodiment;

FIG. 7 is a front view of a decorative sheet set as a comparison target of the embodiment;

FIG. 8 is a front view of a decorative structure as a comparison target of the embodiment;

FIG. 9 is a front view of a decorative sheet set as another comparison target of the embodiment;

FIG. 10 is a front view of a decorative sheet set as another comparison target of the embodiment;

FIG. 11 is a front view of a decorative sheet set as another comparison target of the embodiment;

FIG. 12 is a front view of a decorative structure as another comparison target of the embodiment;

FIG. 13 is a front view of another embodiment of the decorative sheet set of the present disclosure;

FIG. 14 is a view of a decorative sheet set as a comparison target of the another embodiment;

FIG. 15 is a view of a decorative sheet set as another comparison target of the another embodiment;

FIG. 16 is a schematic diagram of a method for measuring a harmonious impression received from the decorative structure of the present disclosure;

FIG. 17 is a front view of decorative sheets included in the decorative sheet set of the present disclosure;

FIG. 18 is a front view of an example of the decorative structure of the present disclosure;

FIGS. 19A to 19C are each a front view of decorative sheets included in the decorative sheet set of the present disclosure;

FIGS. 20A to 20D are each a schematic diagram of an aspect not included in the decorative structure of the present disclosure;

FIG. 21 is a front view of four types of decorative sheets of Embodiment 2-1;

FIG. 22 is a front view of two types of decorative sheets having characteristic patterns of Embodiment 2-1;

FIG. 23 is a front view of a decorative structure of Embodiment 2-1;

FIG. 24 is a front view of four types of decorative sheets of Embodiment 2-2;

FIG. 25 is a front view of two types of decorative sheets having characteristic patterns of Embodiment 2-2;

FIG. 26 is a front view of a decorative structure of Embodiment 2-2;

FIG. 27 is a front view of four types of decorative sheets of Embodiment 2-3;

FIG. 28 is a front view of two types of decorative sheets having characteristic patterns of Embodiment 2-3;

FIG. 29 is a front view of a decorative structure of Embodiment 2-3;

FIG. 30 is a front view of four types of decorative sheets of Embodiment 2-4;

FIG. 31 is a front view of two types of decorative sheets having characteristic patterns of Embodiment 2-4;

FIG. 32 is a front view of a decorative structure of Embodiment 2-4; and

FIG. 33 is a view illustrating a manufacturing process of decorative sheets.

### DESCRIPTION OF EMBODIMENTS

### 1. Embodiment 1

### 1-1. Overview

A decorative sheet set 1 of the present embodiment includes a plurality of decorative sheets 11 to 16. The plurality of decorative sheets 11 to 16 have appearance designs different from one another. A variation in the appearance designs among the plurality of decorative sheets 11 to 16 is within a predetermined range.

The decorative sheet set 1 of the present embodiment includes a plurality of types of decorative sheets 11 to 16. To form a decorative structure 10 made up of the plurality of decorative sheets 11 to 16 such that the decorative structure 10 makes a harmonious impression, the decorative sheet set 1 includes one each of the decorative sheets 11 to 16 having surfaces provided with appearance designs different from one another. The decorative structure is a decorative structure having a surface constituting a decorative surface of a building and is a structural component visually perceivable from outside the building. Examples of the decorative structure include an exterior wall, an inside wall, a roof, a ceiling, and a floor. Moreover, surfaces of the decorative sheets 11 to 16 are surfaces facing an outdoor side of the decorative sheets 11 to 16 and are visually perceivable from outside when the decorative sheets 11 to 16 are installed. the decorative surface is composed of the decorative sheets 11 to 16. The appearance designs include, for example, printed patterns, textured patterns, and a combination pattern of the printed patterns and the textured patterns formed on the surfaces of the decorative sheets 11 to 16.

In the case of the decorative sheet set 1 of the present embodiment, preparing one or more decorative sheet sets 1 in accordance with the size of the decorative structure and randomly installing two or more types of decorative sheets 11 to 16 selected from the one or more decorative sheet sets 1 can also form a decorative structure having an appearance which makes no incongruous impression. Moreover, the way the two or more types of decorative sheets 11 to 16 are arranged can create variations.

### 1-2. Details

### <Decorative Sheet Set>

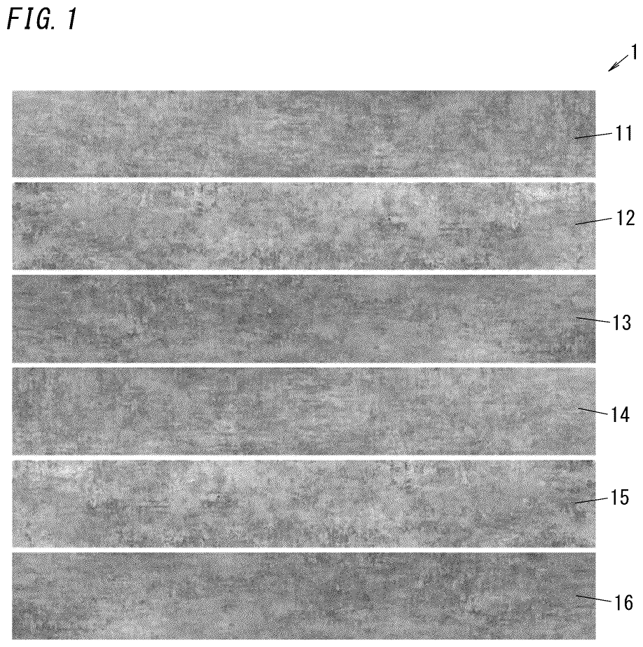

FIG. 1 shows a front view of the decorative sheet set 1 of the present embodiment. The decorative sheet set 1 includes the decorative sheets 11 to 16. Specifically, the decorative sheet set 1 includes six types of decorative sheets 11 to 16. That is, the six types of decorative sheets 11 to 16 are included in the decorative sheet set 1. Note that the number of types of decorative sheets included in the decorative sheet set 1 is not limited to six but is at least two and has no particular upper limit.

In the present embodiment, the decorative sheets 11 to 16 are exterior wall materials but are not limited to this example. Examples of the exterior wall materials include ceramic-based siding materials including hardened cement as a main component. Moreover, when the decorative sheets 11 to 16 are the exterior wall materials, the decorative sheets 11 to 16 may be plate materials each having, for example, a length of 600 to 6000 mm and a width of 300 to 2400 mm. However, the length and the width are not limited to this example. Each of the decorative sheets 11 to 16 is, but is not limited to being, rectangular in front view.

The surface of each of the decorative sheets 11 to 16 has a design region. A design in the design regions of the decorative sheets 11 to 16 is common to the decorative sheets 11 to 16. When the surfaces of the decorative sheets 11 to 16 are surfaces of which a decorative surface is composed, and the decorative sheets 11 to 16 are the exterior wall materials, the surfaces of the decorative sheets 11 to 16 are surfaces facing an outdoor side. In the present embodiment, the design is a concept including at least one element selected from the group consisting of luminance, brightness, saturation, hue, and shade. Saying that the design is common means that one or more of the elements included in the designs of the design regions are in common. Moreover, saying that the appearance designs are different from each other means, for example, that one or more of the elements included in the designs of the design regions are different from each other. The design region can include, for example: a printed pictorial pattern; a textured pattern and a texture expressed by the textured pattern; or a combination pattern of the printed pictorial pattern with the textured pattern and the texture expressed by the textured pattern. The surfaces of the decorative sheets 11 to 16 partially have the design regions, or the entire surfaces of the decorative sheets 11 to 16 are the design regions. The surfaces of the decorative sheets 11 to 16 have the design regions, and thereby, the decorative sheets 11 to 16 have respective individual appearance designs. The design region includes one or more of, for example: a colored part provided with a predetermined color; shade resulting from forming recesses and projections; coated projections and uncoated recesses resulting from subjecting the projections and the recesses to coating by using, for example, a roll coater, a flexographic printer, or a gravure offset printer; or a portion having a surface with different degrees of gloss. The colored part may include a plurality of types of colored parts classified based on color differences. For example, a pattern can be formed by three types of colored parts 21, 22, and 23 different from one another in terms of color and provided in a distributed manner. Thus, the three types of colored parts 21, 22, and 23 different from one another in terms of color can provide the appearance designs to the decorative sheets 11 to 16. Moreover, examples of the pattern include an artificial pattern (e.g., brick, wood grain) imitating natural things and a random pattern.

A difference between a proportion of the area of the design region in one decorative sheet (any one of 11 to 16) selected from the decorative sheets 11 to 16 to the area of the surface of the one decorative sheet (the one of 11 to 16) and a proportion of the area of the sum of the design regions of all the decorative sheets 11 to 16 to the area of the sum of the surfaces of all the decorative sheets 11 to 16 is within a predetermined range. That is, the difference between the proportion of the area of the design region in one decorative sheet arbitrarily selected from the plurality of decorative sheets 11 to 16 to the area of the surface of the one decorative sheet and the proportion of the sum of the areas of the design regions in the plurality of decorative sheets 11 to 16 to the sum of the areas of the surfaces of the plurality of decorative sheets 11 to 16 is within the predetermined range.

When the design region is a colored part provided with a color, a color difference ΔE₁ between the colored parts of two decorative sheets arbitrarily selected from the plurality of decorative sheets 11 to 16 is preferably within a predetermined range. In this case, it can be said that the design is common to the design regions. The color difference ΔE₁ is a difference between color values of the colored parts. For example, the color difference ΔE₁ is preferably less than or equal to 25.0, more preferably less than or equal to 15.0, much more preferably less than or equal to 10.0.

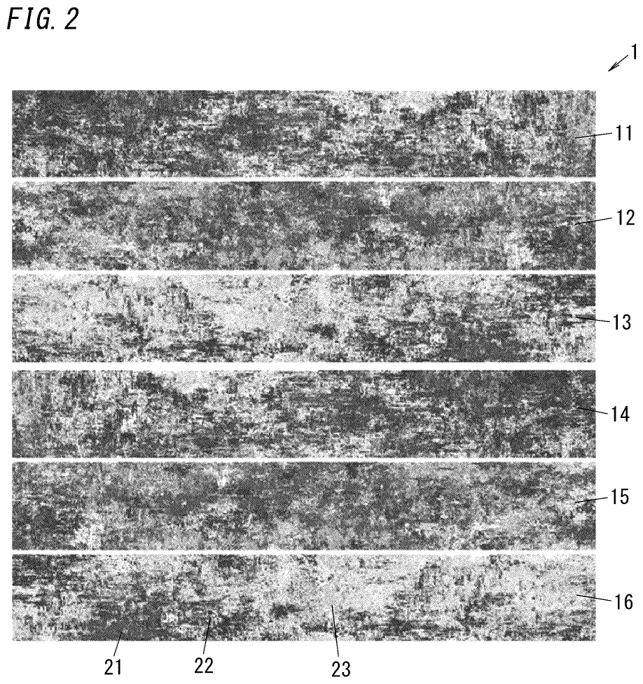

The surfaces of the decorative sheets 11 to 16 of the present embodiment are each flat. Moreover, a design common to the decorative sheets 11 to 16 includes the colored parts 21, 22, and 23 provided with colors common to the decorative sheets 11 to 16 (common colors). That is, when each of the decorative sheets 11 to 16 includes the colored parts 21, 22, and 23 provided with the common colors, it can be said that the design is common to the design regions. The colored parts 21, 22, and 23 include, for example: respective dots formed by an ink-jet printing method, portions transferred from respective recesses in an engraved plate in a gravure offset printing method or the like; or portions transferred from respective projections of a letterpress plate in a flexographic printing method. The colored parts 21, 22, and 23 are formed over the entire surface of each of the decorative sheets 11 to 16. Therefore, regions having a pattern common to the decorative sheets 11 to 16 are parts where the colored parts 21, 22, and 23 are located. In FIG. 2, a red colored part 21, a blue colored part 22, and a yellow colored part 23 are shown, but the colors of the colored parts 21 to 23 are not limited to this example. For example, each of the decorative sheets 11 to 16 may have only one type of colored part. That is, each of the decorative sheets 11 to 16 may be colored with one type of common color. Moreover, the colored parts may have achromatic colors such as black, white, and gray. Each of the decorative sheets 11 to 16 may have a plurality of types of only achromatic colored parts. That is, each of the decorative sheets 11 to 16 may have a monotonous pattern.

For example, each of the plurality of decorative sheets 11 to 16 has, as the design regions, a plurality of colored parts 21, 22, and 23 having colors different from each other. The color of each of the plurality of colored parts 21, 22, and 23 is common to the plurality of decorative sheets 11 to 16. A proportion of area of at least one colored part of the plurality of colored parts may be different among the plurality of decorative sheets 11 to 16. Moreover, the plurality of colored parts 21, 22, and 23 may occupy locations different from one another in each of the plurality of decorative sheets 11 to 16. That is, each of the decorative sheets 11 to 16 may have the plurality of colored parts 21, 22, and 23 occupying locations different from one another and having common colors different from one another. That is, the red colored part 21, the blue colored part 22, and the yellow colored part 23 having respective different common colors (red, blue, and yellow) are formed at a plurality of different locations on the surface of the decorative sheet 11, and the red colored part 21, the blue colored part 22, and the yellow colored part 23 occupy respective different regions.

At least one of the proportion, location, or color of the design regions in the surfaces of the decorative sheets 11 to 16 is different among the decorative sheets 11 to 16. For example, when the proportion of the design regions in the surface of the decorative sheet 11, the proportion of the design regions in the surface of the decorative sheet 12, and the proportion of the design regions in the surface of the decorative sheet 13 are respectively denoted by X₁₁, X₁₂, and X₁₃, respective values of X₁₁, X₁₂, and X₁₃ are different from one another. That is, the decorative sheets 11 to 13 are different, for each type, in terms of the proportion of a region decorated in each of the plurality of common colors.

More specifically, when the proportion of the total of an area occupied by the red colored part 21, an area occupied by the blue colored part 22, and an area occupied by the yellow colored part 23 in the surface of the decorative sheet 11, the proportion of the total of an area occupied by the red colored part 21, an area occupied by the blue colored part 22, and an area occupied by the yellow colored part 23 in the surface of the decorative sheet 12, and the proportion of the total of an area occupied by the red colored part 21, an area occupied by the blue colored part 22, and an area occupied by the yellow colored part 23 in the surface of the decorative sheet 13 are respectively denoted by Y₁₁, Y₁₂, and Y₁₃, values of Y₁₁, Y₁₂, and Y₁₃ are different from one another. That is, the proportion of the total of the area occupied by the red colored part 21, the area occupied by the blue colored part 22, and the area occupied by the yellow colored part 23 is different among the decorative sheets 11 to 13. Therefore, in the decorative sheets 11 to 13, the proportion of the region decorated in each of the plurality of common colors is different for each of the decorative sheets. Thus, the decorative sheet set 1 including the decorative sheets 11 to 13 includes a combination of a predetermined number of decorative sheets 11 to 13 having similar patterns but having different distribution degrees of the common colors.

Moreover, the design regions of the decorative sheet 14 correspond to the design regions of the decorative sheet 11 inverted in a left/right direction in FIG. 2. Similarly, the design regions of the decorative sheet 15 and the design regions of the decorative sheet 16 respectively correspond to the design regions of the decorative sheet 12 and the design regions of the decorative sheet 13 inverted in the left/right direction in FIG. 2. When the proportion of the design regions in the surface of the decorative sheet 14, the proportion of the design regions in the surface of the decorative sheet 15, and the proportion of the design regions in the surface of the decorative sheet 16 are respectively denoted by X₁₄, X₁₅, and X₁₆, relationships, expressed as X₁₁=X₁₄, X₁₂=X₁₅, and X₁₃=X₁₆, hold true. The decorative sheets 11 to 16 may be different from one another in terms of the locations of the design regions while having the same proportion of the design regions. Thus, the proportions or locations of the design regions in the surfaces of the decorative sheets 11 to 16 are different from one another.

Note that when the proportion of the design regions in the surface of the decorative sheet 11, the proportion of the design regions in the surface of the decorative sheet 12, the proportion of the design regions in the surface of the decorative sheet 13, the proportion of the design regions in the surface of the decorative sheet 14, the proportion of the design regions in the surface of the decorative sheet 15, and the proportion of the design regions in the surface of the decorative sheet 16 are respectively denoted by X₁₁, X₁₂, X₁₃, X₁₄, X₁₅ and X₁₆, values of X₁₁, X₁₂, X₁₃, X₁₄, X₁₅, and X₁₆ may be different from one another. In this case, the proportions of the colored regions are, for each of the plurality of common colors, all different among the plurality of decorative sheets 11 to 16.

In contrast, the proportions of the design regions in the surfaces of the decorative sheets 11 to 16 may all be equal to one another. That is, a relationship, as expressed X₁₁=X₁₂=X₁₃=X₁₄=X₁₅=X₁₆, may hold true. However, in this case, the decorative sheets 11 to 16 are different from one another in terms of the locations of the design regions in the surfaces thereof. For example, the decorative sheets 11 to 16 may be different from one another at least in terms of the location(s) of all, or at least any one, of the red colored parts 21, the blue colored parts 22, and the yellow colored parts 23 in the surfaces thereof.

The proportion of a total area of the plurality of colored parts 21 to 23 to each of the decorative sheets 11 to 16 is preferably higher than or equal to 40% of the area of the surface of a corresponding one of the decorative sheets 11 to 16. That is, when the total area of the plurality of colored parts 21 to 23 in the decorative sheet 11, the total area of the plurality of colored parts 21 to 23 in the decorative sheet 12, the total area of the plurality of colored parts 21 to 23 in the decorative sheet 13, the total area of the plurality of colored parts 21 to 23 in the decorative sheet 14, the total area of the plurality of colored parts 21 to 23 in the decorative sheet 15, and the total area of the plurality of colored parts 21 to 23 in the decorative sheet 16 are respectively denoted by S₁₁, S₁₂, S₁₃, S₁₄, S₁₅ and S₁₆, and an entire surface area of each of the decorative sheets 11 to 16 is denoted by Z, relationships, expressed as (S₁₁/Z)≥0.4, (S₁₂/Z)≥0.4, (S₁₃/Z)≥0.4, (S₁₄/Z)≥0.4, (S₁₅/Z)≥0.4, and (S₁₆/Z)≥0.4, hold true. Thus, parts colored with the common colors (the colored parts 21 to 23) occupy higher than or equal to 40% of each of the decorative sheets 11 to 16, and therefore, the decorative sheets 11 to 16 have a common appearance. The proportion of a total area of the plurality of colored parts 21 to 23 to each of the decorative sheets 11 to 16 is more preferably higher than or equal to 50% of the area of the surface of the corresponding one of the decorative sheets 11 to 16. Note that an upper limit of the proportion is 100%. In this case, the total areas S₁₁ to S₁₆ of the areas of the plurality of colored parts 21 to 23 are respectively equal to the entire surface area Z of each of the decorative sheets 11 to 16.

In addition, the difference between the proportion of the area of the design regions in one decorative sheet arbitrarily selected from the plurality of decorative sheets 11 to 16 to the area of the surface of the one decorative sheet and the proportion of the sum of the areas of the design regions in the plurality of decorative sheets 11 to 16 to the sum of the areas of the surfaces of the plurality of decorative sheets 11 to 16 is within the predetermined range. For example, when a proportion of the area of the design regions to the area of the surface of one type of decorative sheet selected from the decorative sheets 11 to 16 is denoted by a, and a proportion of the sum of the areas of the design regions of the decorative sheets 11 to 16 to the sum of the areas of the surfaces of the decorative sheets 11 to 16 is denoted by b, the absolute value of the difference (a b) between a and b is within the predetermined range. Thus, the difference between an overall appearance of the decorative sheet set 1 of the decorative sheets 11 to 16 and an appearance of one decorative sheet (any one of 11 to 16) is small. Therefore, installing two or more types of decorative sheets 11 to 16 selected from the decorative sheet set 1 of the decorative sheets 11 to 16 in a random combination can also form a decorative structure having an appearance which makes no incongruous impression. For example, between the appearance of a decorative structure including a plurality of one type of decorative sheets 11 and the appearance of a decorative structure including a plurality of two types of decorative sheets 11 and 12, there is a difference of the appearance, but the difference of the appearance is not very large, and therefore, the appearances make no incongruous impression.

In the present embodiment, the difference between the proportion of the area of the design regions in one decorative sheet arbitrarily selected from the plurality of decorative sheets 11 to 16 to the area of the surface of the one decorative sheet and the proportion of the sum of the areas of the design regions in the plurality of decorative sheets 11 to 16 to the sum of the areas of the surfaces of the plurality of decorative sheets 11 to 16 is preferably greater than or equal to 0% points and less than or equal to 20% points. Thus, installing two or more types of decorative sheets 11 to 16 selected from the decorative sheet set 1 of the decorative sheets 11 to 16 in a random combination also easily forms a decorative structure having an appearance which makes an impression of further reduced incongruity.

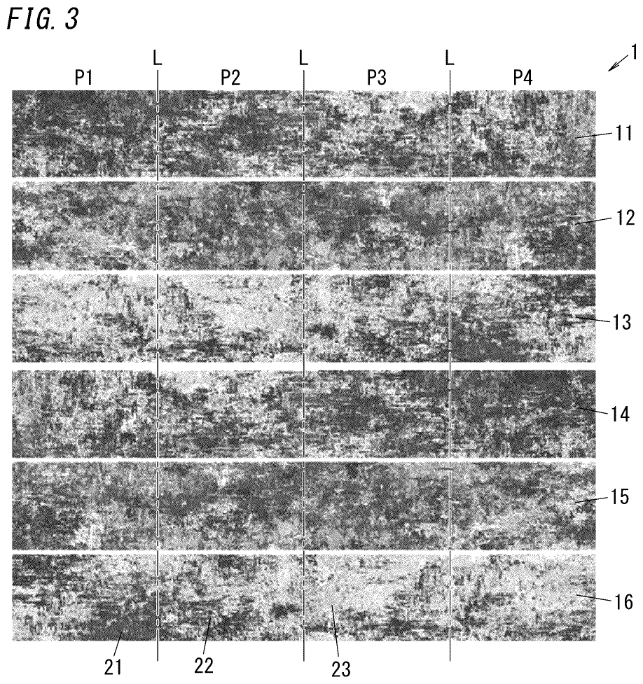

In this embodiment, when each of the plurality of decorative sheets 11 to 16 is divided into four portions (divided portions P1 to P4) identical to one another in terms of shape and area, a proportion of the total area of the colored parts 21 to 23 in each of the divided portions P1 to P4 to an area PZ of a corresponding one of the divided portions P1 to P4 is preferably higher than or equal to 40%. As shown in FIG. 3, for example, the surface of the decorative sheet 11 is divided along virtual lines L into four visually equal divided portions P1, P2, P3, and P4, and the total area of the colored parts 21 to 23 in the divided portion P1, the total area of the colored parts 21 to 23 in the divided portion P2, the total area of the colored parts 21 to 23 in the divided portion P3, and the total area of the colored parts 21 to 23 in the divided portion P4 are respectively denoted by QP₁, QP₂, QP₃, and QP₄. In this case, relationships, expressed as (QP₁/PZ)≥0.4, (QP₂/PZ)≥0.4, (QP₃/PZ)≥0.4, and (QP₄/PZ)≥0.4, hold true. Similar relationships hold true for the decorative sheets 12 to 16 other than the decorative sheet 11. Thus, the parts colored with the common colors (colored parts 21 to 23) occupy higher than or equal to 40% of the divided portion of each of the decorative sheets 11 to 16, and therefore, in any of the decorative sheets 11 to 16, the colored parts 21 to 23 are formed without being unequally distributed. Thus, the decorative sheets 11 to 16 present an overall common appearance. When each of the plurality of decorative sheets 11 to 16 is divided into the four portions (the divided portions P1 to P4) identical to one another in terms of shape and area, the proportion of the total area of the colored parts 21 to 23 in each of the divided portions P1 to P4 to the area PZ of the corresponding one of the divided portions P1 to P4 is more preferably higher than or equal to 50%. Note that the upper limit of this proportion is 100%, and in that case, the total area QP₁ of the colored parts 21 to 23 of the divided portion P1 is equal to the surface area PZ of the divided portion P1, the total area QP₂ of the colored parts 21 to 23 of the divided portion P1 is equal to the surface area PZ of the divided portion P2, the total area QP₃ of the colored parts 21 to 23 of the divided portion P3 is equal to the surface area PZ of the divided portion P3, and the total area QP₄ of the colored parts 21 to 23 of the divided portion P4 is equal to the surface area PZ of the divided portion P4.

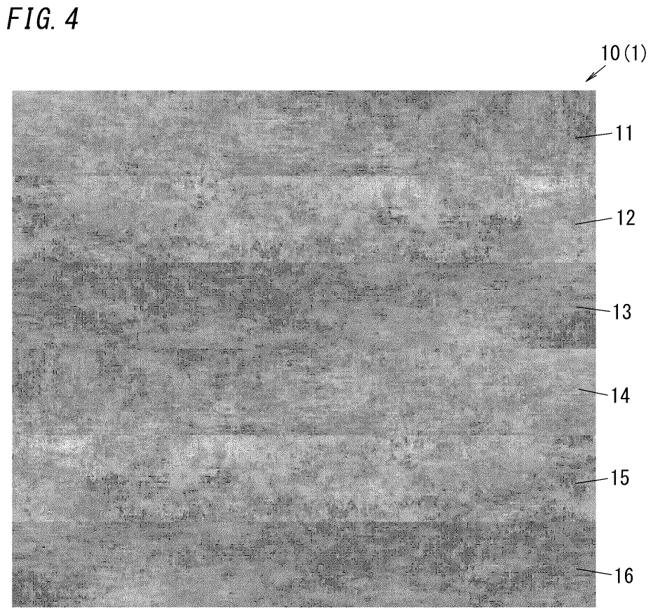

FIG. 4 shows the decorative structure 10 which includes one each of the decorative sheets 11 to 16 to constitute a decorative surface of a building. The decorative structure 10 is a surface visually perceivable from outside the building and is, for example, an outer surface (exposed surface) such as an exterior wall, an inside wall, a roof, a ceiling, or a floor.

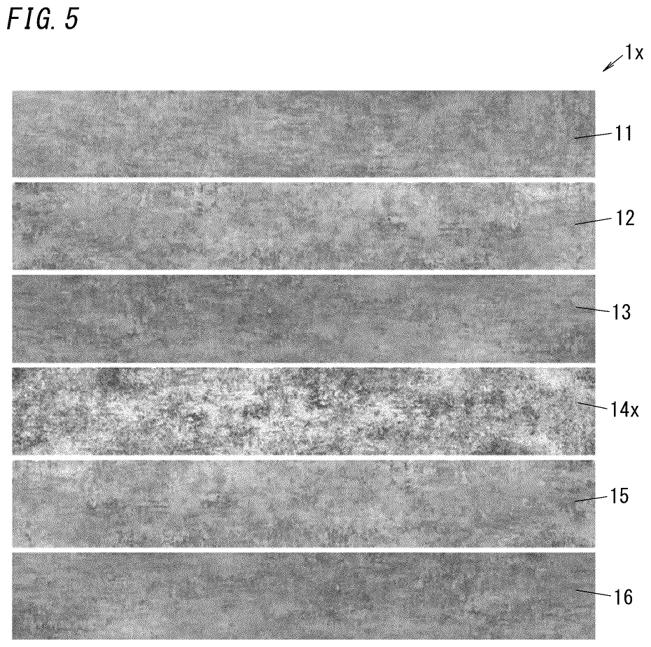

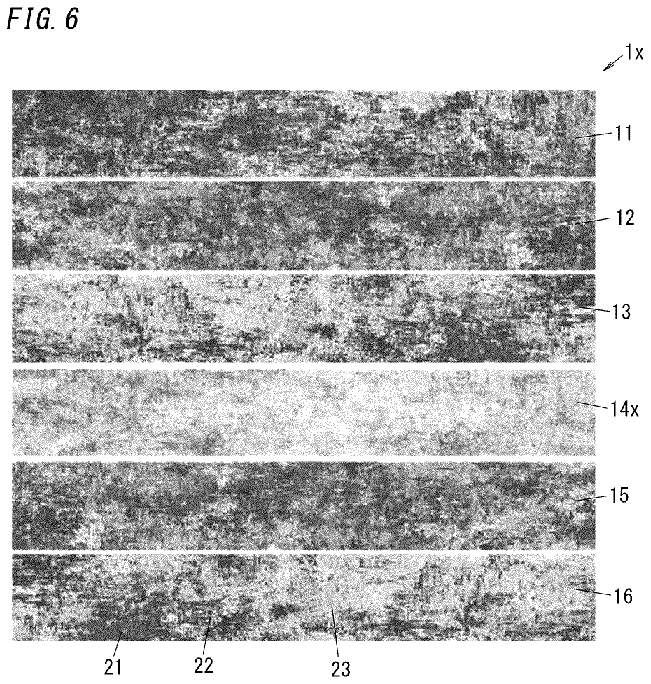

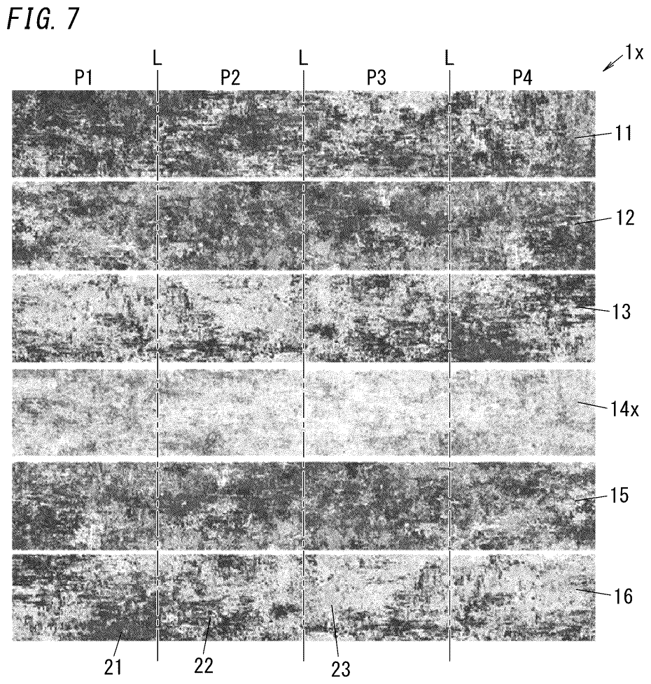

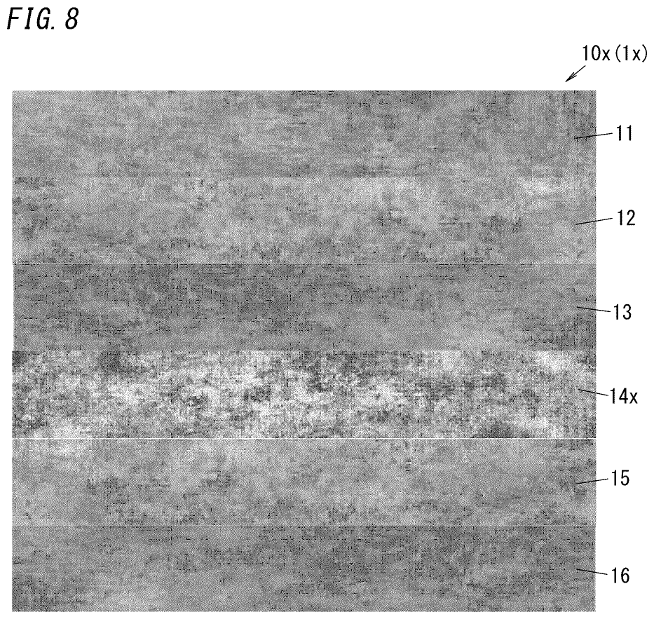

FIG. 5 is a decorative sheet set 1x as a comparison target of the present embodiment. In a similar manner to the decorative sheet set 1, the decorative sheet set 1x includes a plurality of different types of decorative sheets 11, 12, 13, 14x, 15, and 16. Of the decorative sheets 11, 12, 13, 14x, 15, and 16, the decorative sheets 11, 12, 13, 15, and 16 are formed in a similar manner to those in the present embodiment shown in FIG. 1, but the decorative sheet 14x is different from the decorative sheet 14 of the present embodiment. As shown in FIG. 6, the total area of the plurality of colored parts 21 to 23 in the decorative sheet 14x is less than 40% of (is specifically, 20% of) the area of the surface of the decorative sheet 14x. Moreover, as shown in FIG. 7, the total area of the colored parts 21 to 23 in each of divided portions P1 to P4 of the decorative sheet 14x when the decorative sheet 14x is divided into four equal portions is lower than 40% of the area of the surface of a corresponding one of the divided portions P1 to P4. In a decorative structure 10x made up of the decorative sheet set 1x including the decorative sheet 14x, as shown in FIG. 8, it is difficult to form a decorative structure which makes no incongruous impression.

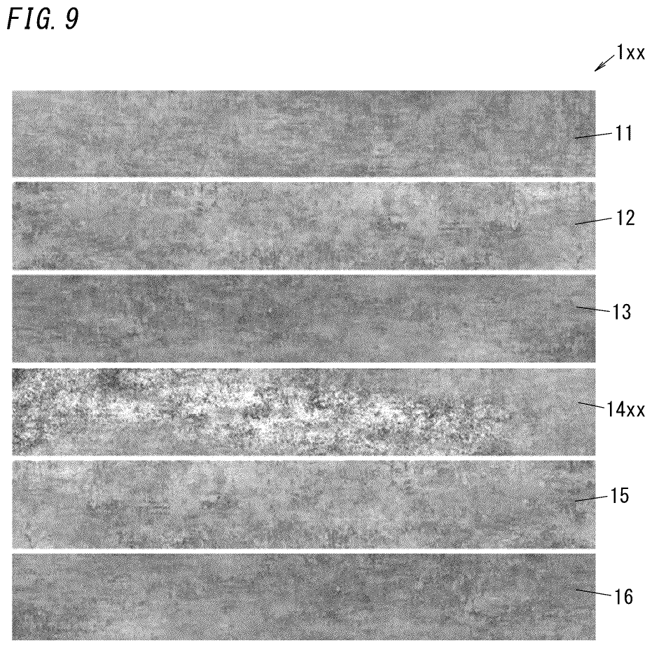

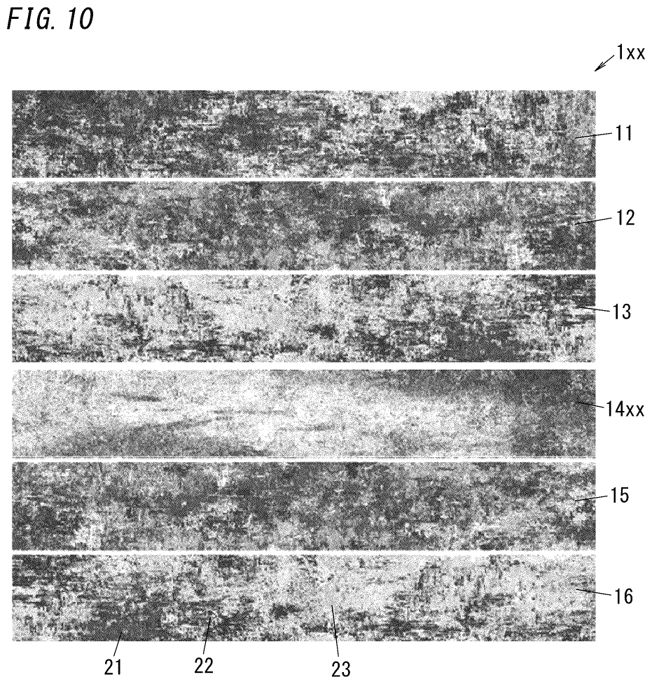

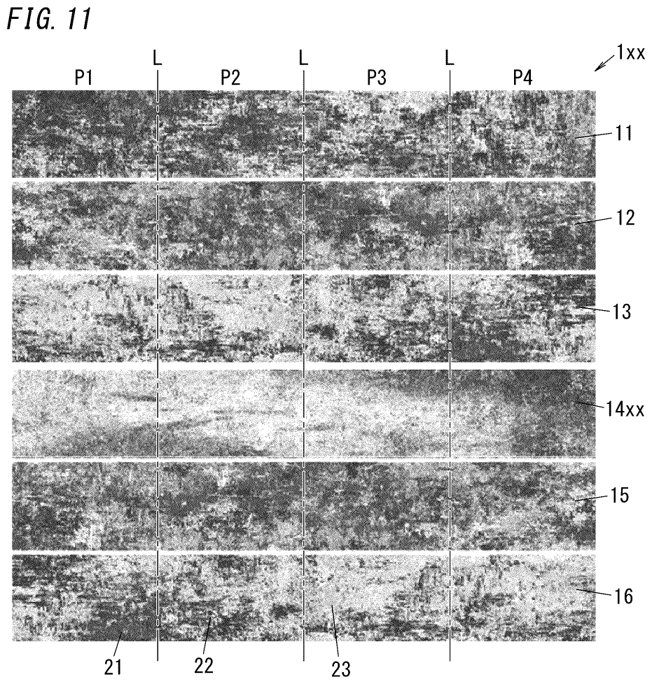

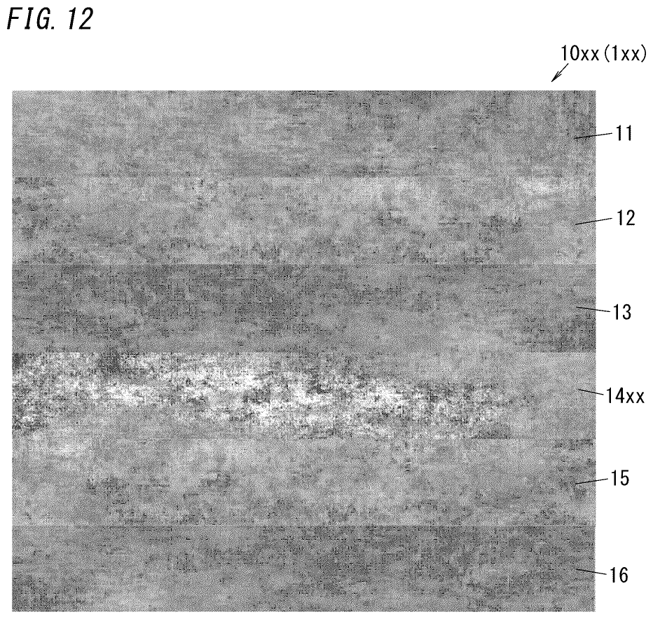

FIG. 9 is a decorative sheet set 1xx as a comparison target of the present embodiment. In a similar manner to the decorative sheet set 1 of the present embodiment, the decorative sheet set 1xx includes a plurality of different types of decorative sheets 11, 12, 13, 14xx, 15, and 16. Moreover, of the decorative sheets 11, 12, 13, 14xx, 15, and 16, the decorative sheets 11, 12, 13, 15, and 16 are formed in a similar manner to those in the present embodiment shown in FIG. 1, but the decorative sheet 14xx is different from the decorative sheet 14 of the present embodiment. As shown in FIG. 10, the total area of the plurality of colored parts 21 to 23 in the decorative sheet 14xx is higher than or equal to 40% of the area of the surface of the decorative sheet 14x. However, as shown in FIG. 11, the total area of the colored parts 21 to 23 of a divided portion P2 of divided portions P1 to P4 of the decorative sheet 14xx when the surface of the decorative sheet 14xx is divided into four equal portions is lower than 40% of (is specifically, 30% of) the area of the surface of the divided portion P2. In a decorative structure 10xx made up of the decorative sheet set 1xx including the decorative sheet 14xx, as shown in FIG. 12, it is difficult to form a decorative structure having an appearance which makes no incongruous impression.

In this embodiment, each of the plurality of decorative sheets 11 to 16 has a non-exposed part which is not exposed outside when the decorative sheets 11 to 16 are installed, and the non-exposed part is preferably provided with an identification mark. The identification mark is different for each of the decorative sheets 11 to 16. Here, an example of the non-exposed part is a tongue. That is, the non-exposed part of each of the decorative sheets 11 to 16 is a portion to be connected to adjacent decorative sheets 11 to 16, for example. In this case, after the decorative sheets 11 to 16 are installed, the identification mark is no longer seen from outside and do not impair the appearance. A plurality of identification marks may be provided along a length direction of the decorative sheets 11 to 16 at predetermined intervals. The predetermined interval is, for example, 455 mm but is not limited to this example. Thus, when the plurality of identification marks are provided, the identification marks remain on the decorative sheets 11 to 16 even after the decorative sheets 11 to 16 are cut, and the decorative sheets 11 to 16 are easily distinguished from one another. The identification mark is different for each of the decorative sheets 11 to 16, and thus, checking the identification marks facilitates distinguishing the decorative sheets 11 to 16 from one another, for example, at the time of installation. Since the decorative sheets 11 to 16 of the present embodiment have similar appearances, the decorative sheets 11 to 16 are difficult to be distinguished from one another based on only their appearances, but the identification marks make it easy to distinguish the decorative sheets 11 to 16 from one another. The identification marks can be formed by printing or engraving a numerical digit, a character, a color, a symbol, and the like. Note that the identification mark may be printed concurrently with printing the patterns on the surfaces of the decorative sheets 11 to 16 or may be printed at a different timing from the printing of the patterns. Note that ink jet printing easily concurrently prints the identification marks and the patterns on the surfaces of the decorative sheets 11 to 16, but in the case of the flexographic printing, the gravure offset printing, and the like, it is difficult to concurrently print the identification marks and the patterns on the surfaces of the decorative sheets 11 to 16. Moreover, the identification marks may be numbers representing locations to which the decorative sheets 11 to 16 are to be affixed. In this case, preparing a drawing provided with the numbers at predetermined parts of the decorative structure which is to be installed enables the craftsperson to correctly install the decorative structure. Moreover, the drawing may be packaged together with the decorative sheets 11 to 16.

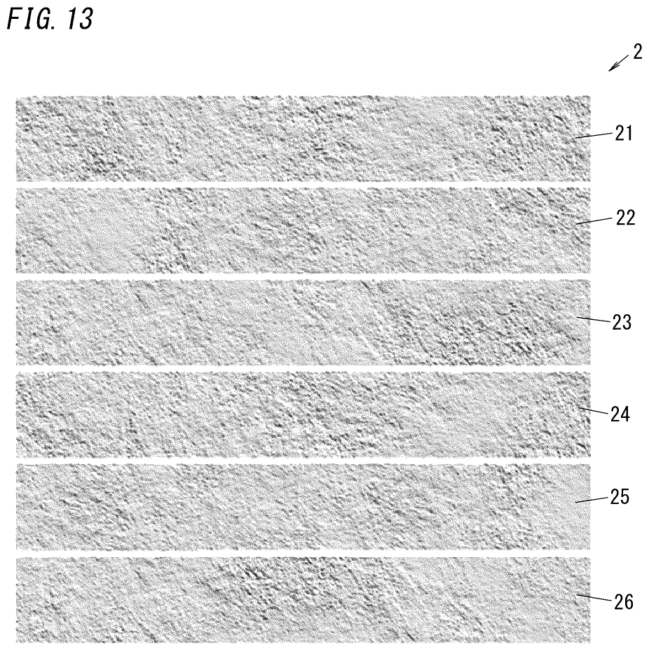

FIG. 13 shows a front view of another decorative sheet set 2 of the present embodiment. The decorative sheet set 2 includes decorative sheets 21 to 26. Specifically, the decorative sheet set 2 includes six types of decorative sheets 21 to 26. That is, six types of decorative sheets 21 to 26 are included in one decorative sheet set 2. The decorative sheets 21 to 26 are exterior wall materials similar to the decorative sheets 11 to 16.

A surface of each of the decorative sheets 21 to 26 has design regions. A design in the design regions of the decorative sheets 21 to 26 is common to the decorative sheets 21 to 26. The design in the design regions includes shade. At least one of the proportion, location, or color of the design regions in the surfaces of the decorative sheets 21 to 26 is different among the decorative sheets 21 to 26 in a similar manner to the decorative sheets 11 to 16. Here, the color includes a color resulting from the shade.

In addition, the difference between the proportion of the area of the design regions in one decorative sheet arbitrarily selected from the plurality of decorative sheets 21 to 26 to the area of the surface of the one decorative sheet and the proportion of the sum of the areas of the design regions in the plurality of decorative sheets 21 to 26 to the sum of the areas of the surfaces of the plurality of decorative sheets 21 to 26 is within the predetermined range in a similar manner to the decorative sheets 11 to 16. For example, when a proportion of the area of the design regions to the area of the surface of one type of decorative sheet selected from the decorative sheets 21 to 26 is denoted by a, and a proportion of the sum of the areas of the design regions to the sum of the areas of the surfaces of the decorative sheets 21 to 26 is denoted by b, the absolute value of the difference (a−b) between a and b is within the predetermined range. Thus, the difference between an overall appearance of the decorative sheet set 2 of the decorative sheets 21 to 26 and an appearance of one decorative sheet (any one of 21 to 26) is small. Thus, installing two or more types of decorative sheets 21 to 26 selected from the decorative sheet set 2 of the decorative sheets 21 to 26 in a random combination can also form a decorative structure having an appearance which makes no incongruous impression.

The difference between the proportion of the area of the design regions in one decorative sheet arbitrarily selected from the plurality of decorative sheets 21 to 26 to the area of the surface of the one decorative sheet and the proportion of the sum of the areas of the design regions in the plurality of decorative sheets 21 to 26 to the sum of the areas of the surfaces of the plurality of decorative sheets 21 to 26 is preferably greater than or equal to 0% points and less than or equal to 20% points in a similar manner to the decorative sheets 11 to 16. Thus, installing two or more types of decorative sheets 21 to 26 selected from the decorative sheet set 1 in a random combination also easily forms a decorative structure having an appearance which makes an impression of further reduced incongruity.

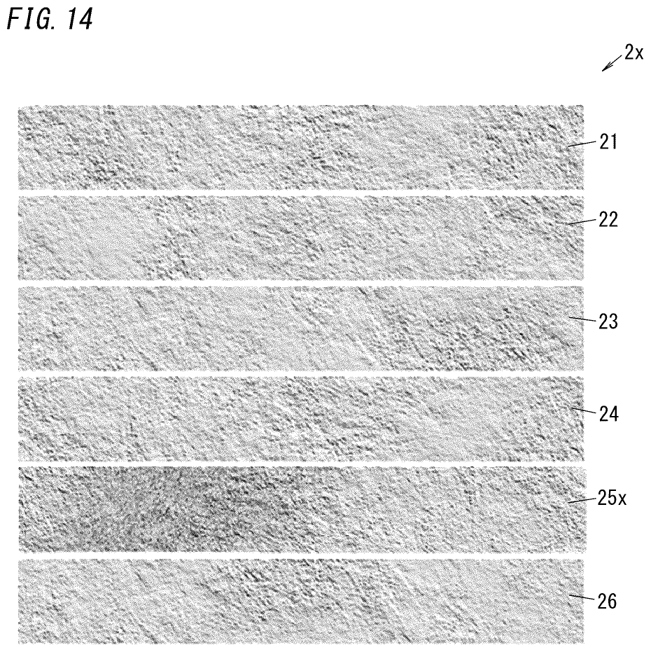

FIG. 14 is a decorative sheet set 2x of a comparison target of the decorative sheet set 2 shown in FIG. 13. In a similar manner to the decorative sheet set 2, the decorative sheet set 2x includes a plurality of different types of decorative sheets 21, 22, 23, 24, 25x, and 26. Of the decorative sheets 21, 22, 23, 24, 25x, and 26, the decorative sheets 21, 22, 23, 24, and 26 are formed in a similar manner to those shown in FIG. 13, but the decorative sheet 25x is different from the decorative sheet 25. The decorative sheet 25x has a larger proportion of the area of the design regions than the decorative sheet 25. That is, the decorative sheet 25x has a larger shade area due to recesses and projections than the decorative sheet 25. Thus, as shown in FIG. 14, the difference between the proportion of the area of the design regions to the area of the decorative sheet 25x and the proportion of the sum of the areas of the design regions to the sum of the areas of the surfaces of the decorative sheets 21 to 26 is greater than 20% point. A decorative structure made up of the decorative sheet set 2x including the decorative sheet 25x is difficult to have an appearance which makes no incongruous impression.

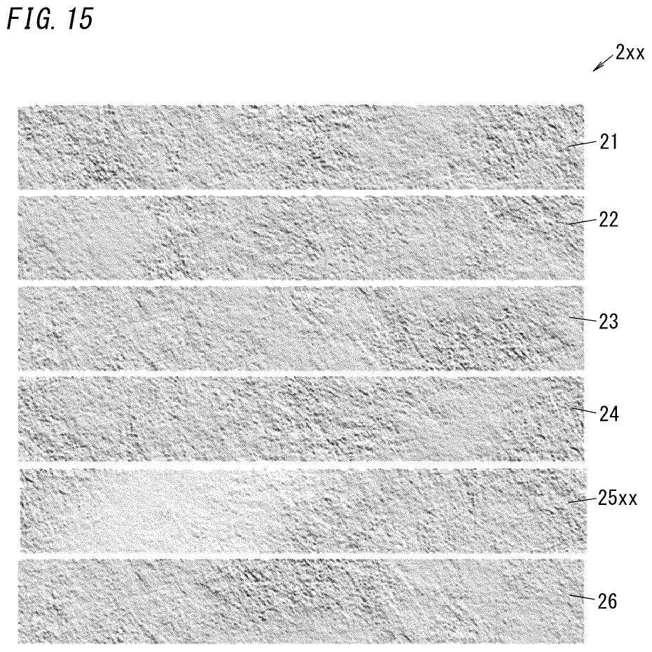

FIG. 15 is a decorative sheet set 2xx as a comparison target of the decorative sheet set 2 shown in FIG. 13. In a similar manner to the decorative sheet set 2, the decorative sheet set 2xx includes a plurality of different types of decorative sheets 21, 22, 23, 24, 25xx, and 26. Of the decorative sheets 21, 22, 23, 24, 25xx, and 26, the decorative sheets 21, 22, 23, 24, and 26 are formed in a similar manner to those shown in FIG. 13, but the decorative sheet 25xx is different from the decorative sheet 25. The decorative sheet 25xx has a smaller proportion of the area of the design regions than the decorative sheet 25. That is, the decorative sheet 25xx has a smaller shade area due to recesses and projections than the decorative sheet 25. Thus, as shown in FIG. 15, the difference between the proportion of the area of the design regions to the area of the surface of the decorative sheet 25xx and the proportion of the sum of the areas of the design regions to the sum of the areas of the surfaces of the decorative sheets 21 to 26 is greater than 20 % point. A decorative structure made up of the decorative sheet set 2x including the decorative sheet 25xx is difficult to have an appearance which makes no incongruous impression.

Note that in a similar manner to the decorative sheets 11 to 16, the decorative sheets 21 to 26 may also be provided with identification marks.

### <Decorative Structure>

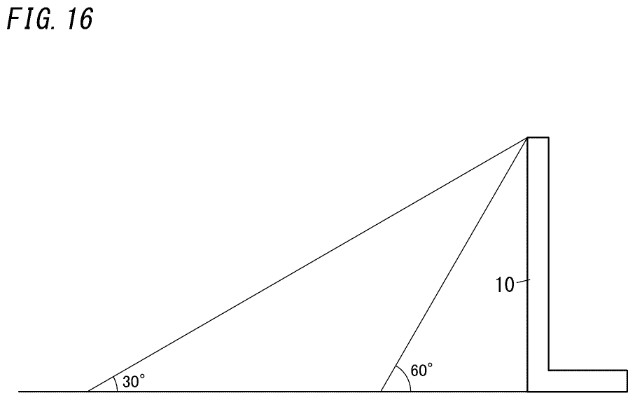

The decorative structure 10 of the present embodiment is made up of a plurality of decorative sheets included in one or more decorative sheet sets. The decorative structure 10 is constructed such that a decorative surface of a building makes a harmonious impression. The decorative structure 10 is visually perceivable from the outside of the building as explained above and constitutes an outer surface (exposed surface) of, for example, an exterior wall, an inside wall, a roof, a ceiling, or a floor. Moreover, the harmonious impression means that in the case of the exterior wall, no incongruous impression is received in observation from a distance at which an upper end of a surface (decorative surface) of the decorative structure 10, which is a target, can be seen at an elevation angle of smaller than or equal to 60 degrees (and lager than or equal to 30 degrees) as shown in FIG. 16. Moreover, when the decorative structure 10 is a surface of the inside wall, the harmonious impression means that no incongruous impression is received in observation of the surface (decorative surface) of the decorative structure 10, which is a target, from a location facing the decorative surface. For example, when higher than or equal to 70% of subjects in a test determine that they receive no incongruous impression from the target, it can be said that the target passed the test (the target makes a harmonious impression).

One decorative structure 10 includes two or more types of decorative sheets 11 to 16 (or 21 to 26) selected from the decorative sheet set 1 (or 2). For example, the decorative structure 10 can be made up of two types of decorative sheets 11 and 12 selected from the decorative sheet set 1. Moreover, for example, the decorative structure 10 can be made up of three types of decorative sheets 11, 15, and 16 selected from the decorative sheet set 1. Moreover, for example, the decorative structure 10 can be made up of six types of decorative sheets 11, 12, 13, 14, 15, and 16 selected from the decorative sheet set 1. The number of each type of the decorative sheets 11 to 16 thus employed is not limited to a particular number. For example, one decorative structure 10 may be made up of three decorative sheets 11 and one decorative sheet 13. Moreover, for example, one decorative structure 10 may be made up of five decorative sheets 16, one decorative sheet 14, and ten decorative sheets 15. One decorative structure 10 constitutes one decorative surface of a building. For example, the decorative surface of one exterior wall of a building is composed of one decorative structure 10.

Thus, in the decorative structure 10 of the present embodiment, the plurality of decorative sheets 11 to 16 have appearance designs different from one other, and the variation in the appearance designs among the plurality of decorative sheets 11 to 16 is within a predetermined range. The appearance design includes a printed pattern, a textured pattern, or a combination pattern of the printed pattern and the textured pattern formed on the surfaces of the decorative sheets 11 to 16. The variation in the appearance designs is defined by, for example, a color difference ΔE_{1(MAX)} between an average color value in a decorative sheet which is included in the plurality of decorative sheets 11 to 16 and whose average color value of the appearance design is highest and an average color value in a decorative sheet which is included in the plurality of decorative sheets 11 to 16 and whose average color value of the appearance design is lowest. In this case, the predetermined range is, for example, less than or equal to 8.0.

First of all, an average color value of the appearance design of each of the plurality of decorative sheets 11 to 16 included in the decorative structure 10 is measured by a chromometer. Examples of the color value include the L* value, a* value, and b* value defined in the L*a*b* color space, and the color difference is a color difference ΔE_{ab} in the L*a*b* color space. Next, the color difference, which is the difference between the average color value which is largest and the average color value which is smallest, is calculated as ΔE_{1(MAX)}. Then, the value of the color difference ΔE_{1(MAX)} of the color values being less than or equal to 8.0 is a preferable condition for the decorative structure 10 of the present embodiment. Note that a range in which the value of the color difference ΔE_{1(MAX)} of the color values is less than or equal to 8.0 is a range in which the appearance designs of the two or more types of decorative sheets 11 to 16 can be determined to be substantially the same when the appearance designs are compared with each other over time, that is, are compared with each other at time intervals.

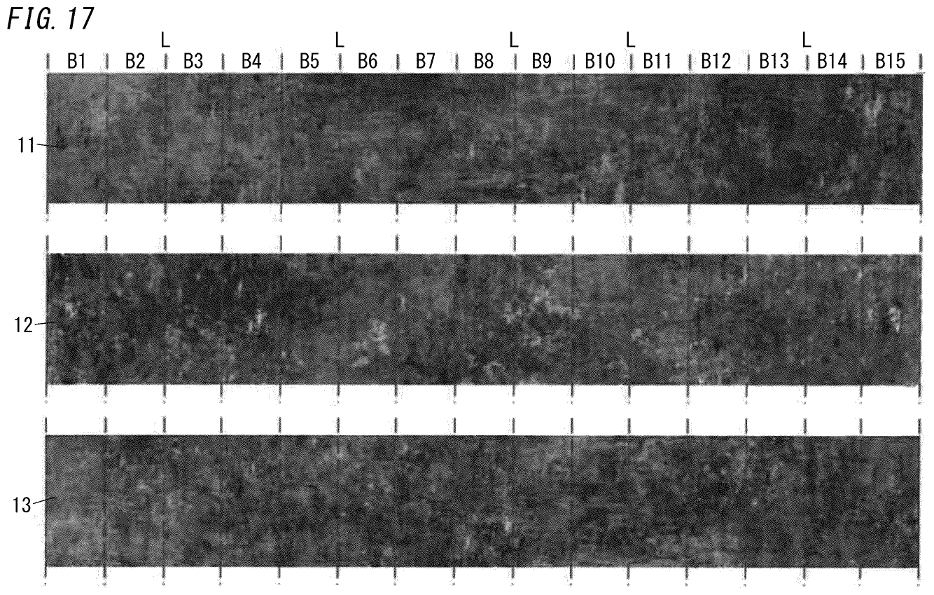

That is, the color difference ΔE_{1(MAX)} is a “color variation (color variation between the sheets)” between two or more types of decorative sheets 11 to 16 and is a variation between average color tones (average color values) of the decorative sheets 11 to 16. For example, respective average color tones of the three decorative sheets 11, 12, and 13 shown in FIG. 17 are measured, the respective average color tones of the decorative sheets 11, 12, and 13 are compared with one another, a color difference which is a difference between the average color tone which is largest and the average color tone which is smallest is calculated as the color difference ΔE_{1(MAX)}, and the value of the color difference ΔE_{1(MAX)} being less than or equal to 8.0 is a preferable condition for the decorative structure 10 of the present embodiment.

Moreover, a relationship expressed as: ΔE_{1(MAX)}≤ΔE_{2(MAX)} is preferably satisfied, where ΔE_{2(MAX)} is a maximum value of values ΔE₂ in the plurality of decorative sheets 11 to 16, each of the values ΔE₂ is a maximum value of a color difference of an average color value between two blocks arbitrarily selected from a plurality of blocks obtained by equally dividing a corresponding one of the plurality of decorative sheets 11 to 16 along virtual edges. For example, in the decorative structure 10 of the present embodiment, each of the two or more types of decorative sheets 11 to 16 is divided into a plurality of equal blocks B1 to B15 along virtual lines L as shown in FIG. 17, values ΔE₂ of color difference of an average color value of the appearance design between two blocks selected from the blocks B1 to B15 are compared with each other, and a color difference ΔE_{2(MAX)} whose value is largest preferably satisfies ΔE_{1(MAX)}≤ΔE_{2(MAX)}. That is, the color difference ΔE₂ is a “color variation (color variation in a sheet)” in each of the decorative sheets 11 to 16 and is a variation caused among average color values of the blocks B1 to B15 when the decorative sheets 11 to 16 is virtually divided into, for example, fifteen blocks B1 to B15 along virtual lines L. For example, each of the three decorative sheets 11, 12, and 13 shown in FIG. 17 is virtually divided into fifteen blocks B1 to B15 along virtual lines L, an average color value of each of the blocks B1 to B15 is measured, and the difference between the average color value which is largest and the average color value which is smallest can be calculated as the value ΔE₂ of the color difference. Of the values ΔE₂ of the color difference specified in the plurality of decorative sheets 11 to 16, the maximum value is ΔE_{2(MAX)}. The maximum value ΔE_{2(MAX)} satisfying the relationship that ΔE_{1(MAX)}≤ΔE_{2(MAX)} is a preferable condition for the decorative structure 10 of the present embodiment.

In the decorative structure 10 of the present embodiment, each of the values ΔE₂ of the color difference is greater than or equal to 1.2 and less than 10.0. In this case, the decorative structure 10 which makes a harmonious impression is easily obtained.

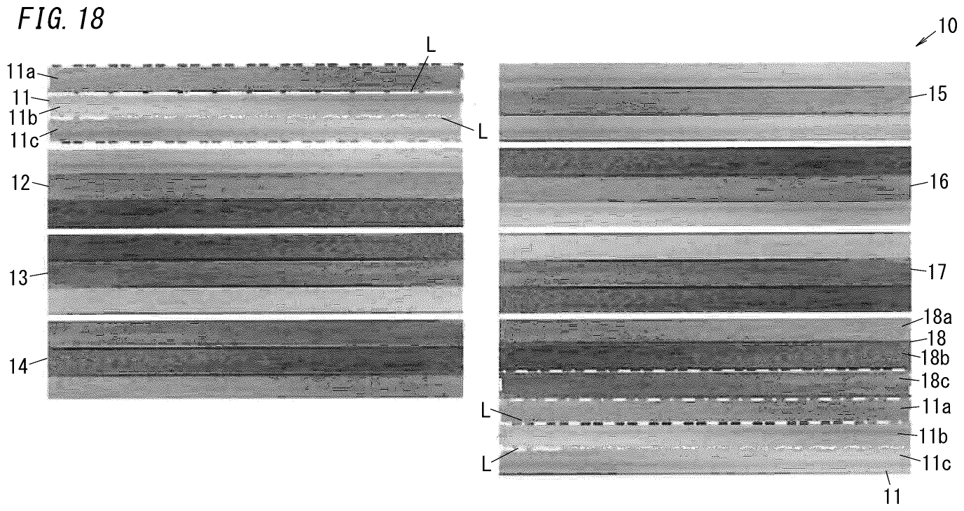

In the decorative structure 10 of the present embodiment, the value ΔE₂ of each of two adjacent decorative sheets arbitrarily selected from a plurality of decorative sheets 11 to 18 and a color difference ΔE₃ of average color values between the two blocks which are each included in a corresponding one of the two decorative sheets and which are adjacent to each other preferably have the relationship that ΔE₃≤ΔE₂. That is, the color difference ΔE₃ between the average color values of the appearance designs of the two adjacent blocks each included in a corresponding one of the two decorative sheets include in the decorative sheets 11 to 18 and vertically or horizontally adjacent to each other preferably satisfies the relationship that ΔE₃≤ΔE₂. For example, as shown in FIG. 18, the decorative sheet 11 and the decorative sheet 18 are vertically adjacent to each other in the decorative structure 10 including the decorative sheets 11 to 18. The decorative sheet 11 is virtually divided into three blocks 11a, 11b, and 11c aligned in an up/down direction along virtual lines L, and the decorative sheet 18 is virtually divided into three blocks 18a, 18b, and 18c aligned in the up/down direction along virtual lines L. A variation in the average color values between the block 11a and the block 18c adjacent to each other is used as the color difference ΔE₃. In this case, the two adjacent decorative sheets 11 and 18 respectively includes the block 11a and the block 18c, and the difference between the average color value of the block 11a and the average color value of the block 18c is the color difference ΔE₃, and the color difference ΔE₃ satisfying the relationship that ΔE₃≤ΔE_{2(MAX)} is a preferable condition for the decorative structure 10 of the present embodiment.

A variation in the appearance designs among the plurality of decorative sheets 11 to 16 in the decorative structure 10 of the present embodiment may be defined by a multiplying factor ΔT_{1(MAX)} of a projection ratio in a decorative sheet which is included in the plurality of decorative sheets 11 to 16 and whose projection ratio of the appearance design is highest to a value of a projection ratio in a decorative sheet which is included in the plurality of decorative sheets 11 to 16 and whose projection ratio of the appearance design is lowest. In this case, the predetermined range for the variation in the appearance designs is preferably less than or equal to twofold, that is, the multiplying factor ΔT_{1(MAX)} is preferably less than or equal to 2. In this case, it can be said that the design is common to the design regions.

First of all, an average projection ratio of the appearance design of each of the two or more types of decorative sheets 11 to 16 included in the decorative structure 10 is measured. The projection ratio is a proportion of an area occupied by projections to the surface of each of the decorative sheets 11 to 16 in plan view. That is, in the surface of each of the decorative sheets 11 to 16, portions protruding from recesses and having a certain height are defined as the projections, and the proportion of the area of the projections to the area of the surface of a corresponding one of the decorative sheets 11 to 16 is the projection ratio. Specifically, examples of the projections include projections defined by masonry joints, various sizes of grains, sea-island patterns, and wood grains. Next, the multiplying factor of the largest projection ratio to the smallest projection ratio is calculated as ΔT_{1(MAX)}. The value of ΔT_{1(MAX)} being less than or equal to 2 is a preferable condition for the decorative structure 10 of the present embodiment. Note that a range in which the value of ΔT_{1(MAX)} is less than or equal to 2 is a range in which the appearance designs of the two or more types of decorative sheets 11 to 16 can be determined to be substantially the same when the appearance designs thereof are compared with each other.

That is, ΔT_{1(MAX)} is a “projection variation (projection variation between sheets)” between two or more types of decorative sheets 11 to 16 and is a variation between the projection ratios of the decorative sheets 11 to 16. For example, the projection ratio of each of the six decorative sheets 21 to 26 shown in FIG. 13 is measured, the projection ratios of the decorative sheets 21 to 26 are compared with one another, the multiplying factor of the largest projection ratio to the smallest projection ratio is calculated as ΔT_{1(MAX)}, and the value of ΔT_{1(MAX)} being less than or equal to 2 is a preferable condition for the decorative structure 10 of the present embodiment.

Moreover, a relationship expressed as: ΔT_{1(MAX)}≤ΔT_{2(MAX)} is preferably satisfied, where ΔT_{2(MAX)} is a maximum value of values ΔT₂ in the plurality of decorative sheets 11 to 16 each of the values ΔT₂ is a maximum value of a multiplying factor of a high projection ratio to a low projection ratio between two blocks arbitrarily selected from a plurality of blocks obtained by equally dividing a corresponding one of the plurality of decorative sheets 11 to 16 along virtual edges. For example, each of the three decorative sheets 11, 12, and 13 shown in FIG. 17 is virtually divided into fifteen blocks B1 to B15 along virtual lines L, the projection ratio of each of the blocks B1 to B15 is measured, and the multiplying factor of the largest projection ratio to the smallest projection ratio is calculated as a value ΔT₂. In this case, of the values ΔT₂ specified in the plurality of decorative sheets 11 to 16, a maximum value ΔT_{2(MAX)} satisfying the relationship that ΔT_{1(MAX)}≤ΔT_{2(MAX)} is a preferable condition for the decorative structure 10 of the present embodiment.

In the decorative structure 10 of the present embodiment, each of the values ΔT₂ is preferably greater than or equal to 1 and less than or equal to 3. In this case, the decorative structure 10 having an appearance which makes a harmonious impression is easily obtained.

In the decorative structure 10 of the present embodiment, the value ΔT₂ of each of two adjacent decorative sheets arbitrarily selected from a plurality of decorative sheets 11 to 18 and a multiplying factor ΔT₃ of a high projection ratio to a low projection ratio between two blocks which are each included in a corresponding one of the two decorative sheets and which are adjacent to each other preferably have the relationship that ΔT₃≤ΔT₂. For example, as shown in FIG. 18, the decorative sheet 11 and the decorative sheet 18 are vertically adjacent to each other in the decorative structure 10 including the decorative sheets 11 to 18. The decorative sheet 11 is virtually divided into three blocks 11a, 11b, and 11c aligned in the up/down direction along virtual lines L, and the decorative sheet 18 is virtually divided into three blocks 18a, 18b, and 18c aligned in the up/down direction along virtual lines L. The multiplying factor of the projection ratio between the block 11a and the block 18c adjacent to each other is defined as ΔT₃. In this case, the projection ratios of the blocks 11a and 18c adjacent to each other respectively of the decorative sheets 11 and 18 adjacent to each other are measured, and the multiplying factor of the high projection ratio to the low projection ratio between the block 11a and the block 18c is the multiplying factor ΔT₃. The multiplying factor ΔT₃ satisfying the relationship that ΔT₃≤ΔT₂ is a preferable condition for the decorative structure 10 of the present embodiment.

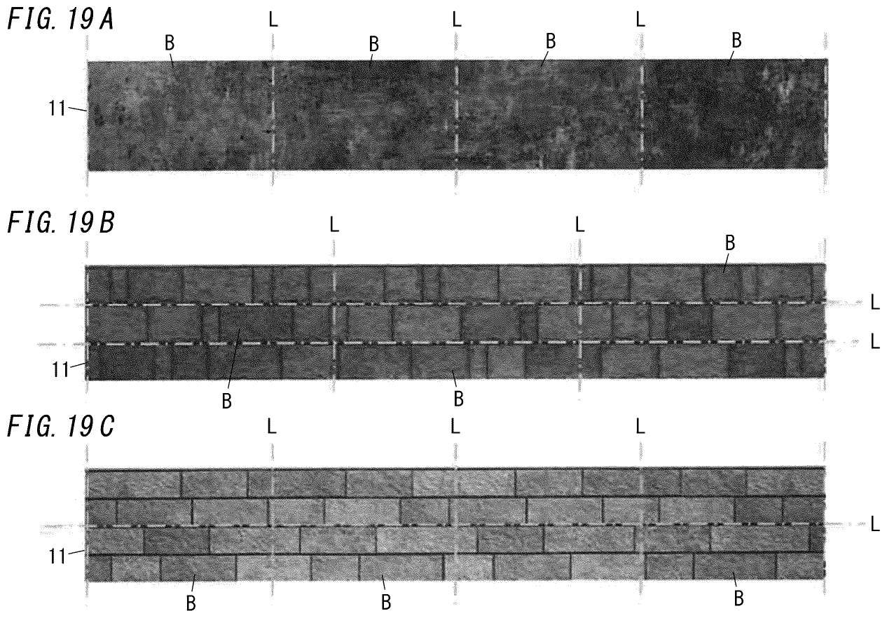

Note that in virtually dividing each of the decorative sheets 11 to 16 into a plurality of blocks along virtual lines L, how each decorative sheet is divided into blocks B is not limited to a particular example. For example, as shown in FIG. 19A, the decorative sheet 11 may be divided into four blocks in the length direction. Alternatively, as shown in FIG. 19B, the decorative sheet 11 may be divided into three blocks in the length direction and into three blocks in the width direction. Still alternatively, as shown in FIG. 19C, the decorative sheet 11 may be divided into four blocks in the length direction and into two blocks in the width direction. The same applies to the decorative sheets 12 to 16.

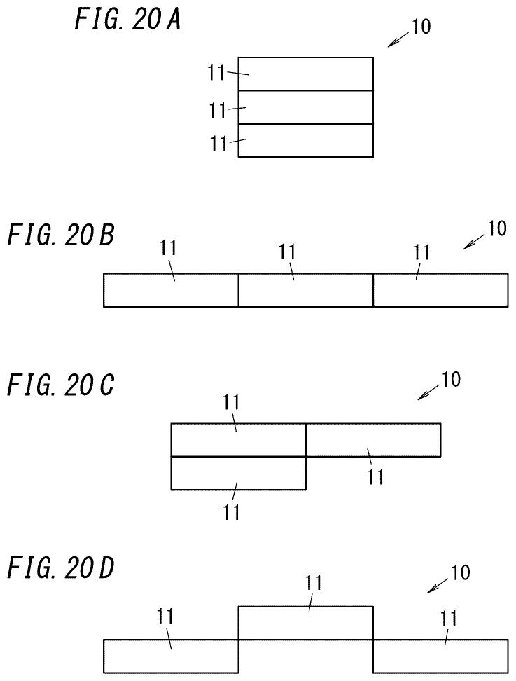

The decorative structure 10 of the present embodiment is made up of the decorative sheets 11 to 16 included in one or more decorative sheet sets 1. Preferably, in the decorative structure 10, three or more decorative sheets having appearance designs identical to one another are not arranged in succession. Note that to be arranged in succession means that the decorative sheets are adjacent to each other vertically, horizontally, or diagonally. That is, of the decorative sheets 11 to 16, the same type of three or more decorative sheets are preferably not successively arranged adjacent to each other. For example, the decorative structure 10 preferably includes no portion in which the same type of three decorative sheets 11 are successively arranged in the up/down direction (in the width direction) as shown in FIG. 20A. Moreover, the decorative structure 10 includes no portion in which the same type of three decorative sheets 11 are arranged in the left/right direction (in the length direction) as shown in FIG. 20B. Further, the decorative structure 10 preferably includes no portion in which the same type of decorative sheets 11 are successively arranged in the up/down direction (in the width direction) and in the left/right direction (in the length direction) as shown in FIG. 20C. Furthermore, the decorative structure 10 preferably includes no portion in which the same type of three decorative sheets 11 are successively arranged diagonally as shown in FIG. 20D. The same applies to the decorative sheets 12 to 16. Thus, the decorative structure 10 having an appearance which makes a harmonious impression is easily obtained while the decorative surface of the building has a prescribed variation.

### <Method for Constructing Decorative Structure>

A method for constructing the decorative structure 10 of the present embodiment includes: a step of determining disposition locations of the plurality of decorative sheets 11 to 16 included in one or more decorative sheet sets 1 on an installation target surface; and a step of installing the plurality of decorative sheets 11 to 16 on the disposition location thus determined. At the time of selecting two or more types of decorative sheets 11 to 16 from the decorative sheet set(s) 1, the same type of a plurality of decorative sheets 11 to 16 may be selected, or some decorative sheets of the decorative sheets 11 to 16 do not have to be selected, in accordance with a desired appearance of the decorative structure 10. The installation target surface is a surface on which the decorative sheets 11 to 16 are to be installed, and examples of the installation target surface include a surface of a wall backing such as a furring strip of the building. At the time of installing the plurality of decorative sheets 11 to 16, the plurality of decorative sheets 11 to 16 may be aligned in the up/down direction and the left/right direction and may be fixed to the installation target surface by a fixing tool such as screws and nails. Edges of adjacent decorative sheets 11 to 16 may be disposed to abut each other, or the adjacent decorative sheets 11 to 16 may be connected via tongues thereof.

The method for constructing the decorative structure 10 may include: a step of registering a drawing of a building having the installation target surface at a computer; a step of determining disposition locations of the plurality of decorative sheets 11 to 16 on the installation target surface on a screen of the computer by a simulation; a step of displaying the disposition locations thus determined on the drawing; and a step of installing the plurality of decorative sheets 11 to 16 in accordance with the drawing showing the disposition locations. That is, in the step of determining disposition locations of the plurality of decorative sheets 11 to 16 included in the one or more decorative sheet sets 1 on the installation target surface, for example, a simulation using a computer can determine the disposition locations of the decorative sheets 11 to 16 on the installation target surface. In this case, the method for constructing the decorative structure 10 may include a step of registering a drawing of a building having the installation target surface at a computer. Moreover, at the time of determining the disposition locations of the decorative sheets 11 to 16 on the installation target surface, a proposer (a manufacturer of the decorative sheets, an architect studio, or the like) may determine disposition locations and propose the disposition locations to a customer of the building. Moreover, while viewing the drawing of the building displayed on a screen of the computer, the proposer and the customer can determine the appearance designs and the disposition locations of the decorative sheets 11 to 16. Further, the customer by himself/herself can determine the appearance designs and the disposition locations by using online software and the like provided by the proposer. Furthermore, at the time of determining the appearance designs and the disposition locations of the decorative sheets 11 to 16, a simulation is preferably performed by using, for example, artificial intelligence (AI) to be able to construct a decorative surface which makes a harmonious impression. Moreover, the decorative sheets 11 to 16 are not carried in stock but are preferably available on demand.

Moreover, the method for constructing the decorative structure 10 of the present embodiment preferably includes a step of loading and packing the plurality of decorative sheets 11 to 16 in an order according to the disposition locations of decorative sheets 11 to 16 thus determined. Thus, the decorative sheets 11 to 16 are loaded and packed in the order of installation, and installation work of the decorative sheets 11 to 16 is easily carried out. For example, when the decorative sheets 11 to 16 are packed in the order of installation, determining a rule of the order of installation may dispense a layout plan of the decorative sheets 11 to 16. Note that the decorative sheets 11 to 16 may be packed by type, and in that case, the decorative sheets 11 to 16 can be installed in accordance with the layout plan of the decorative sheets 11 to 16.

### (Variations)

Embodiment 1 is a mere example of various embodiments of the present disclosure. Various modifications may be made to Embodiment 1 depending on design or the like as long as the object of the present disclosure is achieved.

In the decorative sheets 11 to 16, the plurality of different common colors included in the design are formed at a plurality of different locations on the surfaces of the decorative sheets 11 to 16 and occupy different regions, but this should not be construed as limiting. The plurality of different common colors may overlap each other at some locations.

The decorative sheets 11 to 16 are not limited to the exterior wall materials but may be inside wall materials, tiles, ceiling materials, floor materials, wall paper, or decorative films.

The surfaces of the decorative sheets 11 to 16 may have patterns such as a pattern consisting of three wood-grain parts and/or relief engravings.

### 2. Embodiment 2

### 2-1. Overview

Embodiment 2 of the present disclosure will be described below. Note that the present disclosure is not limited to the embodiment described below. Embodiment 2 described below is a mere example of various embodiments of the present disclosure and may be modified variously depending on design or the like as long as the object of the present disclosure is achieved.

A decorative structure 33 of Embodiment 2 is a structural component constituting, for example, interior surfacing or exterior surfacing of a building. The decorative structure 33 is, for example, a structural component constituting a wall such as an exterior wall or an interior wall, a roof, a ceiling, or a floor. The decorative structure 33 is preferably a structural component (wall structure body) constituting a wall.

The decorative structure 33 has a decorative surface 331. The decorative surface 331 is a surface of the decorative structure 33 exposed outside and is, for example, a wall surface, a roof surface, a ceiling surface, or a floor surface. The decorative surface 331 has a plurality of individual patterns 32 arranged in one direction (hereinafter also referred to as an arrangement direction). The decorative surfaces 331 is part of an outer surface, and a collection of a plurality of the decorative surfaces 331 constitutes the outer surface. The arrangement direction may be the up/down direction, may be the horizontal direction, or may be a direction tilted with respect to the horizontal direction and the up/down direction as long as it is a direction along the outer surface.

The decorative surface 331 has an overall pattern 320. The overall pattern 320 is a collection of a plurality of individual patterns 32 arranged in one direction (hereinafter also referred to as an arrangement direction) along the decorative surface 331.

The overall pattern 320 and the individual patterns 32 may be a color pattern made up of colors and diagrams, or may be a textured pattern made up of recess-and-projection forms. The overall pattern 320 and the individual patterns 32 may be a combination (combination pattern) of the color pattern and the textured pattern.

The individual patterns 32 may all have a pattern of the same motif or may have a pattern of motifs different from each other. When all of the individual patterns 32 have a pattern of the same motif, the overall pattern 320 can make a harmonious impression. Saying that all of the individual patterns 32 have a pattern of the same motif means, for example, that all of the individual pattern 32 have a wood-grain pattern, that all of the individual patterns 32 have a brick pattern, or that all of the individual patterns 32 have a stone surface pattern.

The plurality of individual patterns 32 indispensably include a plurality of individual patterns 32 having patterns different from each other and optionally include a plurality of individual patterns 32 having patterns identical to each other. Assume that a group including one or more individual patterns 32 is referred to as an individual pattern group. In this case, it can be said that the overall pattern 320 includes a plurality of individual pattern groups, the patterns of the individual patterns 32 are the same in each individual pattern group, and the patterns of the individual patterns 32 are different between different individual pattern groups.

The plurality of individual patterns 32 include characteristic patterns 321 and non-characteristic patterns 322. The characteristic patterns 321 are individual patterns 32 having characteristic patterns. The non-characteristic patterns 322 are individual patterns 32 having no characteristic pattern.

It can be said that the overall pattern 320 includes an individual pattern group (characteristic pattern group) having one or more characteristic patterns 321 and an individual pattern group (non-characteristic pattern group) including one or more non-characteristic patterns 322. In this case, the patterns of the individual patterns 32 (characteristic patterns 321) included in the characteristic pattern group may be the same or may be different from each other. Similarly, the patterns of the individual patterns 32 (non-characteristic patterns 322) included in the non-characteristic pattern group may be the same or may be different from each other. That is, two or more types of individual patterns 32 having patterns different from each other may all be the characteristic patterns 321, and similarly, two or more individual patterns 32 having patterns different from each other may all be the non-characteristic patterns 322.

The characteristic pattern is a pattern that the degree of a change in an element making up the pattern is higher than the degree of an average change grasped from the overall pattern 320. The element making up the pattern is, for example, a color, a diagram, or recesses and projections.

For example, in the case of identifying, based on the degree of a change in the color, whether a pattern which is a color pattern is the characteristic pattern 321 or the non-characteristic pattern 322, the pattern is identified as being the characteristic pattern 321 when a maximum color difference between colors making up the pattern is greater than 10, whereas the pattern is identified as being the non-characteristic pattern 322 when the maximum color difference between the colors making up the pattern is less than or equal to 10. In this case, when a person observes the outer surface, the characteristic pattern 321 appears to be more emphasized than the non-characteristic pattern 322. The color difference is, for example, the color difference ΔE_{ab} in the L*a*b* color space. The color difference is measured by, for example, a color difference meter or a spectrophotometric colorimeter. Examples of the spectrophotometric colorimeter include “SP60” manufactured by X-Rite, Inc. Note that in the individual pattern 32, a color which draws no attention of the viewer and which is in a portion having a very small area is not included in the colors making up the pattern.

Each decorative surface 331 has no periodicity in the order in which the characteristic patterns 321 and the non-characteristic patterns 322 appear in the arrangement direction.

The periodicity as used herein means that a certain number of characteristic patterns 321 and a certain number of non-characteristic patterns 322 repeatedly and alternately appear. For example, the entirety of the decorative surface 331 has a periodicity when one characteristic pattern 321 and one non-characteristic pattern 322 appear repeatedly and alternately, when two characteristic patterns 321 and one non-characteristic pattern 322 appear repeatedly and alternately, and when one characteristic pattern 321 and two non-characteristic patterns 322 appear repeatedly and alternately. In Embodiment 2, the arrangement of the individual patterns 32 has no such periodicity. Note that the arrangement of the individual patterns 32 arranged in the arrangement direction may partially have the periodicity as long as the entire arrangement of the individual patterns 32 has no periodicity.

In Embodiment 2, the characteristic patterns 321, which are the characteristic patterns, do not appear periodically. Therefore, an appropriate extent of irregularity is imparted to the overall pattern 320 of each decorative surface 331, and a viewer who views the overall pattern 320 is less likely to experience unnaturalness. That is, even when a plurality of types of patterns are randomly arranged, periodic appearance of the characteristic patterns may make the viewer feel regularity from the overall pattern 320. However, in Embodiment 2, the characteristic patterns do not appear periodically, so that the viewer is less likely to feel the regularity from the overall pattern 320. This can improve the design property of the decorative surface 331 of the decorative structure 33.

### 2-2. Details

More specific embodiments of the decorative structure 33 of Embodiment 2 will be described below.

### (1) Embodiment 2-1

In Embodiment 2-1, a decorative structure 33 includes a plurality of decorative sheets 31 arranged in an arrangement direction.

The decorative sheets 31 have individual patterns 32, one for each of the decorative sheets 31. That is, the decorative structure 33 includes the same number of decorative sheets 31 as the number of individual patterns 32 which a decorative surface 331 has, and each decorative sheet 31 has one individual pattern 32.

Each of the decorative sheets 31 includes a base material 313 having, for example, a plate shape, and a coating film covering one principal surface of the base material 313. The principal surface is a surface facing in a thickness direction defined with respect to the base material 313. The coating film imparts the individual pattern 32, which is a color pattern, to the decorative sheet 31.

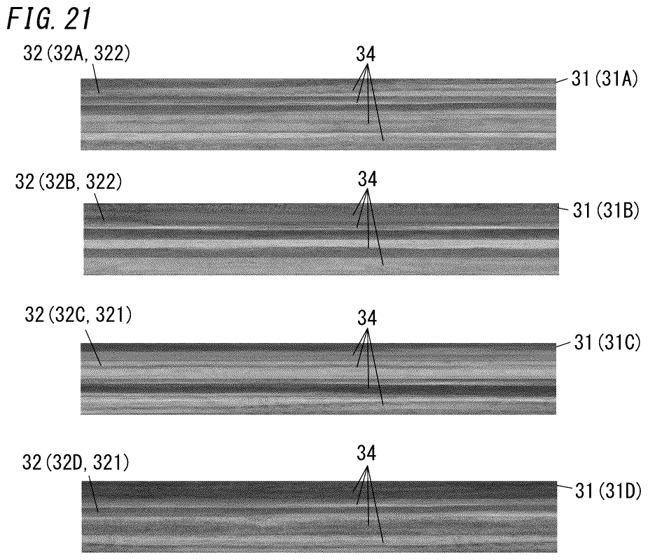

FIG. 21 shows four types of decorative sheets 31 of Embodiment 2-1. The four types of decorative sheets 31 have individual patterns 32 different from one another. That is, FIG. 21 also shows four types of individual patterns 32 of Embodiment 2-1. The four types of individual patterns 32 all have a wood-grain pattern. The outer perimeter of the decorative sheet 31 and the outer perimeter of the individual pattern 32 both have a rectangular shape elongated in one direction. The outer perimeters of the decorative sheets 31 are identical to each other in terms of dimension and shape. The outer perimeters of the individual patterns 32 are identical to each other in terms of dimension and shape. The wood-grain pattern is a straight grain pattern extending along a longitudinal direction of the outer perimeter of the decorative sheet 31 and the outer perimeter of the individual pattern 32.

Each individual pattern 32 is divided into a plurality of pieces 34 by linear boundaries. Each individual pattern 32 shown in FIG. 21 is divided into four pieces 34. The pieces 34 are arranged in a direction orthogonal to the longitudinal direction of the outer perimeter of each individual pattern 32. The decorative sheet 31 has grooves formed at the boundaries each between the pieces 34. In each individual pattern 32, colors change at the boundaries each between the pieces 34.

The four types of decorative sheets 31 shown in FIG. 21 are, for the sake of convenience, referred to as a first type decorative sheet 31A, a second type decorative sheet 31B, a third type decorative sheet 31C, and a fourth type decorative sheet 31D sequentially from the top in FIG. 21. Moreover, the individual patterns 32 of the first type decorative sheet 31A, the second type decorative sheet 31B, the third type decorative sheet 31C, and the fourth type decorative sheet 31D are respectively referred to as a first type individual pattern 32A, a second type individual pattern 32B, a third type individual pattern 32C, and a fourth type individual pattern 32D.

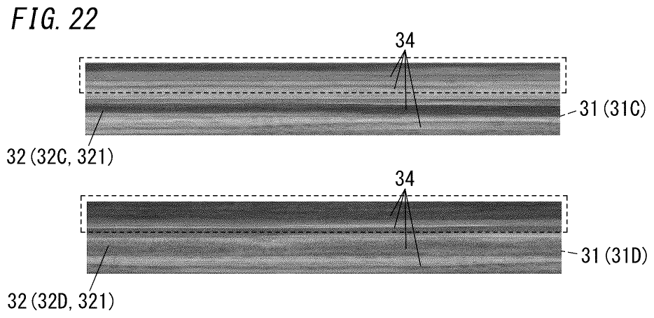

Each of the third type individual pattern 32C and the fourth type individual pattern 32D has a deep color portion with particularly low intensity in the pieces 34 surrounded by a broken line in FIG. 22, and therefore, a maximum color difference between the colors making up the pattern is greater than 10. Thus, the third type individual pattern 32C and the fourth type individual pattern 32D are the characteristic patterns 321. In contrast, in the first type individual pattern 32A and the second type individual pattern 32B, a maximum color difference between the colors is less than or equal to 10, and thus, the first type individual pattern 32A and the second type individual pattern 32B are the non-characteristic patterns 322.

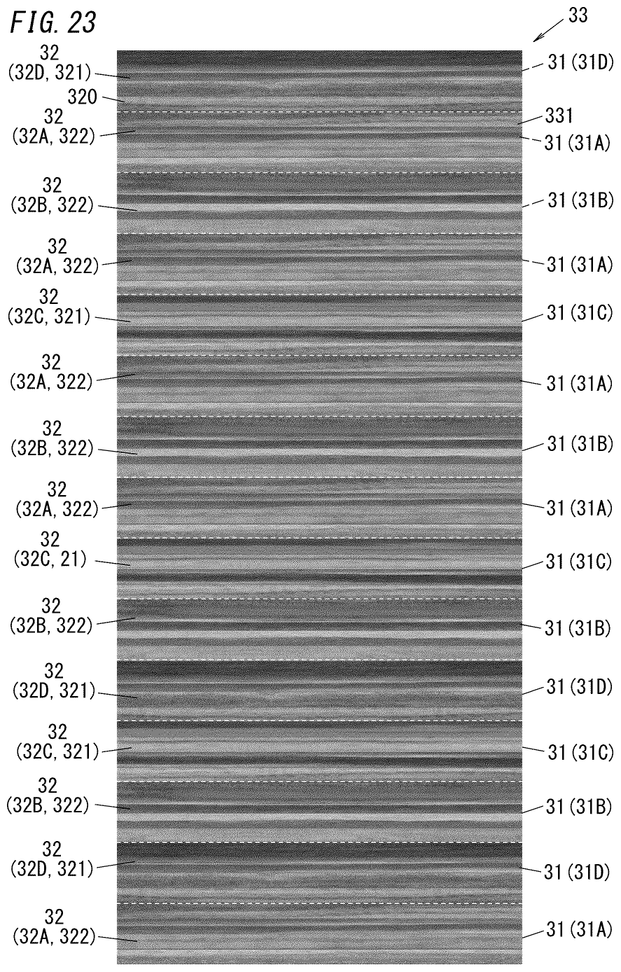

FIG. 23 shows the decorative structure 33 including the decorative sheets 31. The decorative structure 33 can be formed by fixing the decorative sheets 31 to, for example, an underlying material or the like of a building. The arrangement direction in the decorative structure 33 is the up/down direction in FIG. 23. The decorative structure 33 includes fifteen decorative sheets 31 arranged in the arrangement direction, that is, the overall pattern 320 of the decorative structure 33 includes fifteen individual patterns 32 arranged in the arrangement direction.

As shown in FIG. 23, in the overall pattern 320, one characteristic pattern 321, three non-characteristic patterns 322, one characteristic pattern 321, three non-characteristic patterns 322, one characteristic pattern 321, one non-characteristic pattern 322, two characteristic patterns 321, one non-characteristic pattern 322, one characteristic pattern 321, and one non-characteristic pattern 322 sequentially appear from the top of FIG. 23 in the arrangement direction. The first to ninth decorative sheets sequentially from the top have periodicity that one characteristic pattern 321 and three characteristic patterns 321 alternately appear, but the arrangement of all the individual patterns 32 has no periodicity. Therefore, from the overall pattern 320, the viewer feels no regularity that the characteristic patterns 321 periodically appear.

In Embodiment 2-1, two adjacent individual patterns 32 arbitrarily selected from the individual patterns 32 included in the overall pattern 320 have patterns different from each other. That is, the individual patterns 32 having the same pattern do not adjacent to each other. In this case, the viewer is much less likely to feel regularity from the overall pattern 320.

In Embodiment 2-1, the outer perimeters of the individual patterns 32 are identical to each other in terms of shape and size as described above.

Moreover, in Embodiment 2-1, the decorative structure 33 is made up of the plurality of decorative sheets 31 arranged in the arrangement direction, and the decorative sheets 31 have individual patterns 32, one for each of the decorative sheets 31. Thus, installing the decorative sheets 31 can form the decorative structure 33. Moreover, the arrangement of the decorative sheets 31 can define the arrangement of the individual pattern 32, and therefore, the overall pattern 320 can easily be embodied. Moreover, when the outer perimeters of the decorative sheets 31 are identical to each other in terms of shape and size, the shape of the decorative sheets 31 can be standardized, thereby increasing the production rate and the transportability of the decorative sheets 31.

Moreover, in Embodiment 2-1, each decorative sheet 31 has one individual pattern 32. This also enables installing the decorative sheets 31 to form the decorative structure 33. Moreover, the arrangement of the decorative sheets 31 can define the arrangement of the individual pattern 32, and therefore, the overall pattern 320 can easily be embodied.

Moreover, in the present embodiment, also when the outer perimeters of the individual patterns 32 are identical to each other in terms of shape and size, and the outer perimeters of the decorative sheets 31 are identical to each other in terms of shape and size, the viewer is less likely to feel regularity from the overall pattern 320 when the individual patterns 32 are arranged as described above.

The proportion of the total number of the non-characteristic patterns 322 to the total number of the individual patterns 32 arranged in the arrangement direction is preferably higher than or equal to 50%. Note that in Embodiment 2-1, the proportion of the total number of the non-characteristic patterns 322 to the total number of the individual patterns 32 arranged in the arrangement direction is (9/15)×100=60(%). When the proportion is higher than or equal to 50%, the non-periodic pattern occupies one-half or more of the area, thereby providing the advantage that a natural pattern can be expressed.

In the overall pattern 320, the total number of individual patterns 32 arranged in the arrangement direction is preferably greater than or equal to 6. Note that in Embodiment 2-1, the total number of individual patterns 32 is 15. When the total number is greater than or equal to 6, there is the advantage that a natural pattern with a reduced repetitive impression can be expressed.

Preferably, the individual patterns 32 in the overall pattern 320 at least include four or more types of individual patterns 32 having patterns different from one another. In Embodiment 2-1, the individual patterns 32 in the overall pattern 320 include four types of individual patterns 32, namely, the first type individual pattern 32A, the second type individual pattern 32B, the third type individual pattern 32C, and the fourth type individual pattern 32D. In this case, the overall pattern 320 can have an appropriate degree of variation in the arrangement direction, and therefore, from the overall pattern 320, the viewer is much less likely to feel regularity that the characteristic patterns 321 periodically appear. The number of types of individual patterns 32 is more preferably three or more, much more preferably four or more.

Preferably, in the overall pattern 320, the characteristic patterns 321 do not appear four or more in succession, and the non-characteristic patterns 322 do not appear three or more in succession in the arrangement direction. Note that in Embodiment 2-1, the number of characteristic patterns 321 which successively appear is three at maximum, and therefore, the characteristic patterns 321 do not appear four or more in succession. Moreover, the number of non-characteristic patterns 322 which successively appear is two at maximum, and therefore, the characteristic patterns 321 do not appear three or more in succession.

When each individual pattern 32 is divided into the plurality of pieces 34 as in Embodiment 2-1, the number of pieces 34 in each individual pattern 32 is preferably less than or equal to eight. When the number of the pieces 34 is greater than eight, a change in color and the like in each individual pattern 32 draw attention of the viewer, and relatively, a change in the appearance resulting from the way the individual patterns 32 are arranged is less likely to draw the attention. That is, it can be said that when the number of pieces 34 in each individual pattern 32 is less than or equal to eight, the effect of reducing unnaturalness in the appearance of the decorative surface 331 of the embodiment is particularly likely to appear.

### (2) Embodiment 2-2

Motifs of an overall pattern 320 and individual patterns 32 in Embodiment 2-2 are wood-grain patterns in a similar manner to Embodiment 2-1. However, each individual pattern 32 in Embodiment 2-1 is divided into four pieces 34, whereas each of the individual patterns 32 in Embodiment 2-2 is divided into eight pieces 34. Except for this point, Embodiment 2-2 has a configuration generally similar to Embodiment 2-1.

Embodiment 2-2 will be described. In Embodiment 2-2, components similar to those in Embodiment 2-1 are denoted in the drawings by the same reference signs as those in Embodiment 2-1, and the description thereof is accordingly omitted.

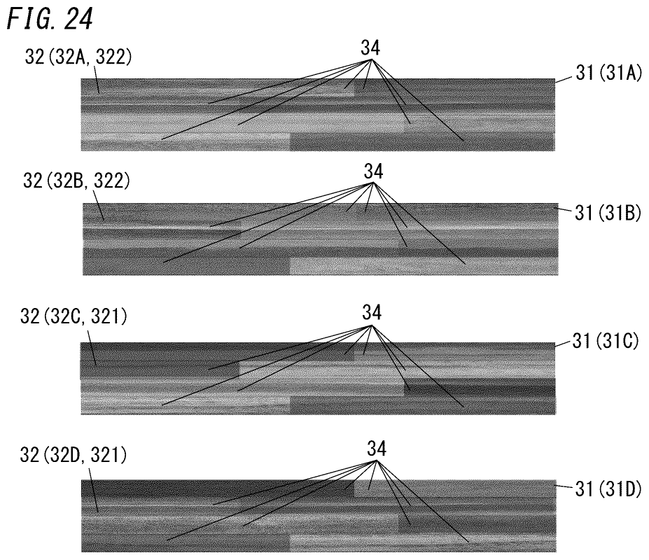

FIG. 24 shows four types of decorative sheets 31 of Embodiment 2-2. The four types of decorative sheets 31 have individual patterns 32 different from one another. The four types of individual patterns 32 all have a wood-grain pattern. The wood-grain pattern is a straight grain pattern extending along a longitudinal direction of the outer perimeter of the decorative sheet 31 and the outer perimeter of the individual pattern 32.

Each individual pattern 32 shown in FIG. 24 is divided into eight pieces 34 along linear boundaries. Each individual pattern 32 includes four rows of pieces 34. In each row, two pieces 34 are aligned in the longitudinal direction of the outer perimeter of the decorative sheet 31 and the outer perimeter of the individual pattern 32, and four rows are arranged in a direction orthogonal to the longitudinal direction. In each decorative sheet 31, grooves are formed at boundaries each between the pieces 34 adjacent to each other. In each individual pattern 32, colors change at the boundaries each between the pieces 34.

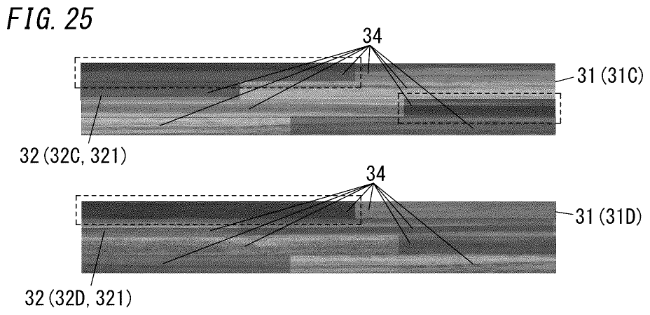

Each of the third type individual pattern 32C and the fourth type individual pattern 32D of Embodiment 2-2 has a deep color portion with particularly low intensity in the pieces 34 surrounded by a broken line in FIG. 25, and therefore, a maximum color difference between the colors making up the pattern is greater than 10. Thus, the third type individual pattern 32C and the fourth type individual pattern 32D are the characteristic patterns 321. In contrast, in the first type individual pattern 32A and the second type individual pattern 32B, a maximum color difference between the colors is less than or equal to 10, and thus, the first type individual pattern 32A and the second type individual pattern 32B are the non-characteristic patterns 322.

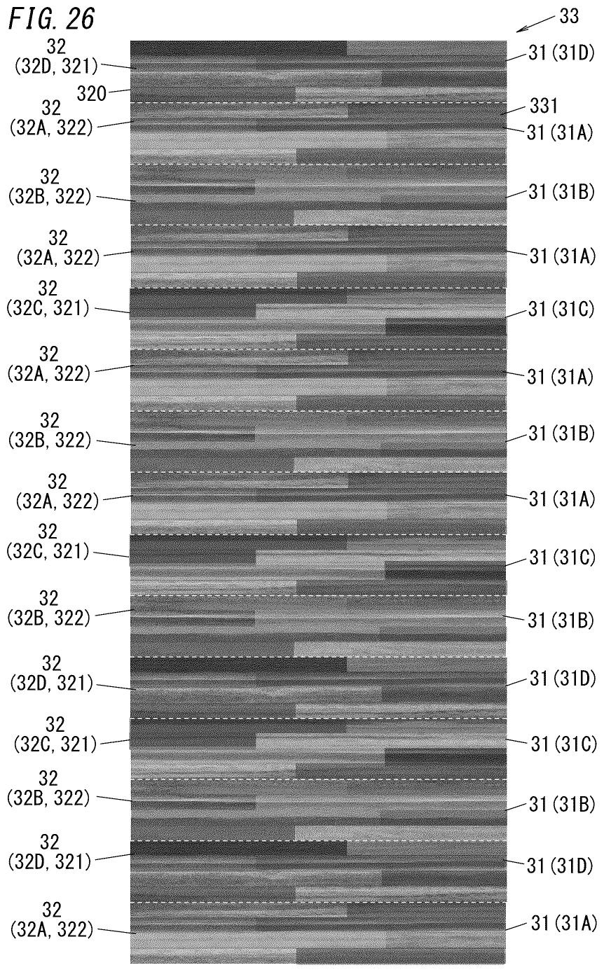

FIG. 26 shows the decorative structure 33 including the decorative sheets 31. The arrangement of the decorative sheets 31 and the individual patterns 32 in the decorative structure 33 is the same as that in Embodiment 2-1.

### (3) Embodiment 2-3

Motifs of an overall pattern 320 and individual patterns 32 in Embodiment 2-3 are stone surface patterns. Moreover, in Embodiment 2-1 and Embodiment 2-2, each individual pattern 32 is divided into a plurality of pieces 34, whereas each individual pattern 32 in Embodiment 2-3 is not divided into pieces 34. Except for this point, Embodiment 2-3 has a configuration generally similar to Embodiment 2-1.

Embodiment 2-3 will be described. In Embodiment 2-3, components similar to those in Embodiment 2-1 are denoted in the drawings by the same reference signs as those in Embodiment 2-1, and the description thereof is accordingly omitted.

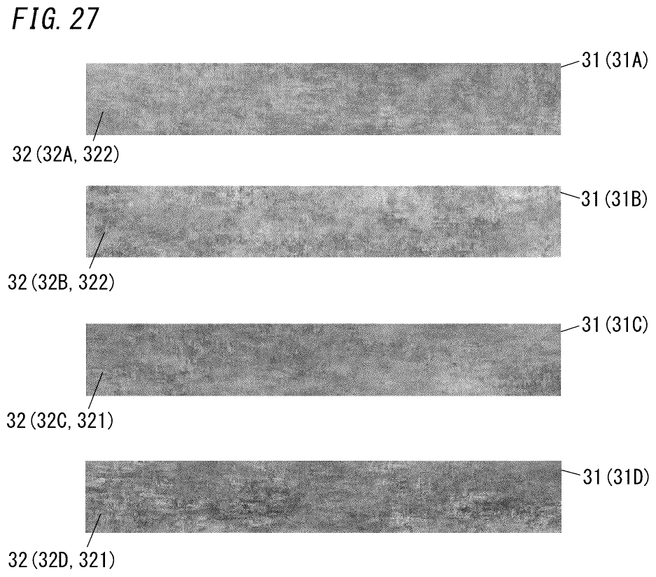

FIG. 27 shows four types of decorative sheets 31 of Embodiment 2-3. The four types of decorative sheets 31 have individual patterns 32 different from one another. The four types of individual patterns 32 all have a stone surface pattern. Each individual pattern 32 shown in FIG. 27 is not divided into pieces 34 as described above.

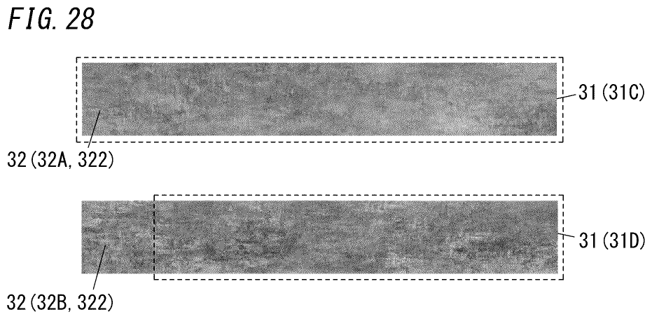

Each of the third type individual pattern 32C and the fourth type individual pattern 32D of Embodiment 2-3 has a deep color portion with particularly low intensity in a portion surrounded by a broken line in FIG. 28, and therefore, a maximum color difference between the colors making up the pattern is greater than 10. Thus, the third type individual pattern 32C and the fourth type individual pattern 32D are the characteristic patterns 321. In contrast, in the first type individual pattern 32A and the second type individual pattern 32B, a maximum color difference between the colors is less than or equal to 10, and thus, the first type individual pattern 32A and the second type individual pattern 32B are the non-characteristic patterns 322.

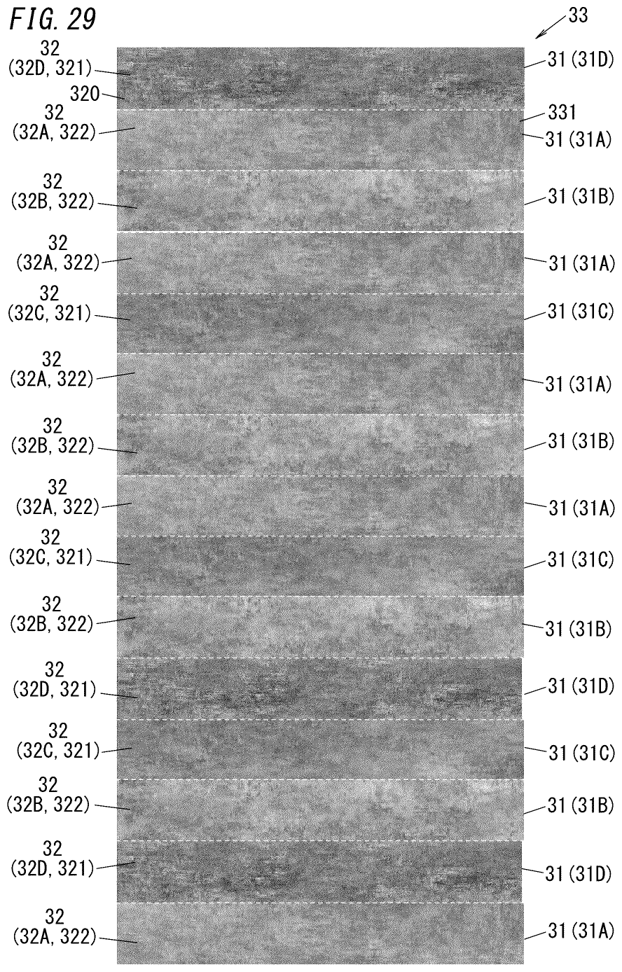

FIG. 29 shows the decorative structure 33 including the decorative sheets 31. The arrangement of the decorative sheets 31 and the individual patterns 32 in the decorative structure 33 is the same as that in Embodiment 2-1.

### (4) Embodiment 2-4

Motifs of an overall pattern 320 and individual patterns 32 in Embodiment 2-4 are stone surface patterns. Each individual pattern 32 in Embodiment 2-1 is divided into four pieces 34, whereas each individual pattern 32 in Embodiment 2-4 is divided into six pieces 34. Except for this point, Embodiment 2-4 has a configuration generally similar to Embodiment 2-1.

Embodiment 2-4 will be described. In Embodiment 2-4, components similar to those in Embodiment 2-1 are denoted in the drawings by the same reference signs as those in Embodiment 2-1, and the description thereof is accordingly omitted.

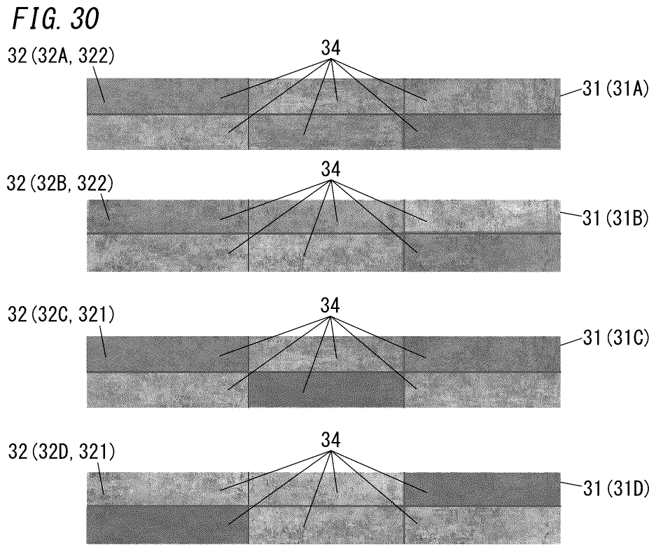

FIG. 30 shows four types of decorative sheets 31 of Embodiment 2-4. The four types of decorative sheets 31 have individual patterns 32 different from one another. The four types of individual patterns 32 all have a stone surface pattern.

Each individual pattern 32 shown in FIG. 30 is divided into six pieces 34 along linear boundaries. Each individual pattern 32 includes two rows of pieces 34. In each row, three pieces 34 are aligned in the longitudinal direction of the outer perimeter of the decorative sheet 31 and the outer perimeter of the individual pattern 32, and two rows are arranged in a direction orthogonal to the longitudinal direction. That is, the pieces 34 are arranged in a matrix having three columns and two rows. In each decorative sheet 31, grooves are formed at boundaries each between the pieces 34 adjacent to each other. In each individual pattern 32, colors change at the boundaries each between the pieces 34.

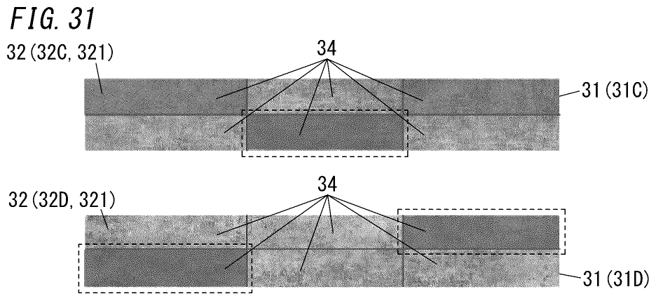

Each of the third type individual pattern 32C and the fourth type individual pattern 32D of Embodiment 2-2 has a deep color portion with particularly low intensity in the pieces 34 surrounded by a broken line in FIG. 31, and therefore, a maximum color difference between the colors making up the pattern is greater than 10. Thus, the third type individual pattern 32C and the fourth type individual pattern 32D are the characteristic patterns 321. In contrast, in the first type individual pattern 32A and the second type individual pattern 32B, a maximum color difference between the colors is less than or equal to 10, and thus, the first type individual pattern 32A and the second type individual pattern 32B are the non-characteristic patterns 322.

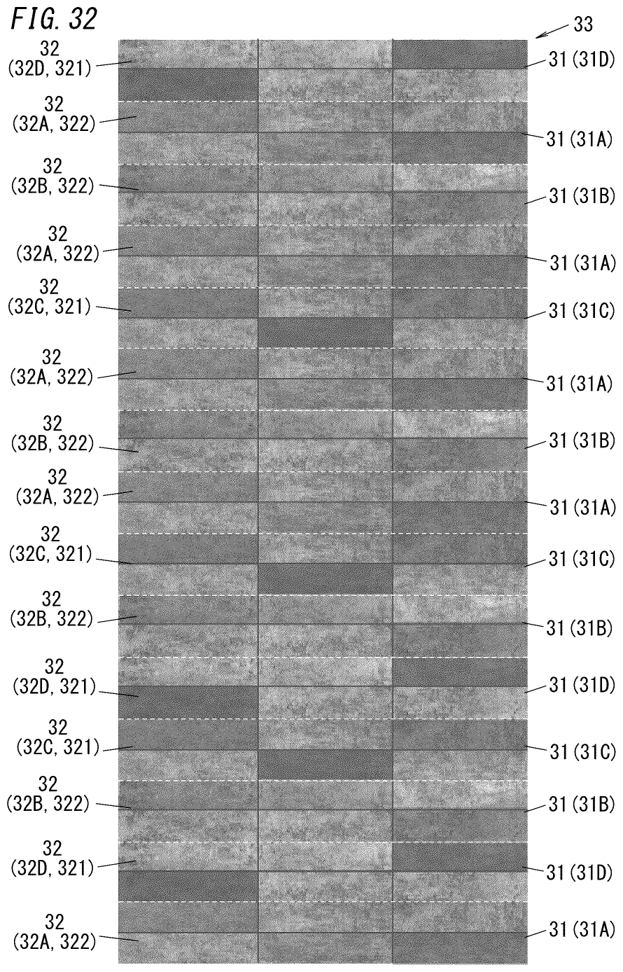

FIG. 32 shows the decorative structure 33 including the decorative sheets 31. The arrangement of the decorative sheets 31 and the individual patterns 32 in the decorative structure 33 is the same as that in Embodiment 2-1.

### (5) Decorative Sheet Set

A decorative sheet set includes the plurality of decorative sheets 31 stacked one on top of another. The number of decorative sheets 31 is the number of decorative sheets 31 included in the decorative structure 33 of, for example, the embodiments and is fifteen in the case of the decorative structure 33 of Embodiment 2-1 to 2-4.

The decorative sheets 31 included in the decorative sheet set are the decorative sheets 31 included in the decorative structure 33 of the embodiment. That is, The decorative sheets 31 have individual patterns 32, one for each of the decorative sheets 31. The plurality of individual patterns 32 indispensably include a plurality of individual patterns 32 having patterns different from each other and optionally include a plurality of individual patterns 32 having patterns identical to each other. The plurality of individual patterns 32 include characteristic patterns 321 and non-characteristic patterns 322, the characteristic patterns 321 are individual patterns 32 having characteristic patterns, and the non-characteristic patterns 322 are individual patterns 32 having no characteristic pattern.

In the decorative sheet set, the order in which the characteristic patterns 321 and the non-characteristic patterns 322 appear in a direction in which the decorative sheet 31 are stacked one on top of another has no periodicity. In the decorative sheet set, the order in which the characteristic patterns 321 and the non-characteristic patterns 322 appear coincide with the order in which the characteristic patterns 321 and the non-characteristic patterns 322 appear in the arrangement direction in the decorative structure 33 of the present embodiment.

When the decorative sheet set is employed, fixing the decorative sheets 31 of the decorative sheet set to, for example, an underlying material of a building in a stacking order of the decorative sheets 31 can construct the decorative structure 33 of the embodiment. Thus, installing a plurality of types of decorative sheets 31 in a predetermined order facilitates the construction of the decorative structure 33.

### (6) Method for Producing Decorative Sheet 31

A method for producing the decorative sheet 31 is a method for sequentially producing a prescribed number of decorative sheets 31. The prescribed number is, for example, the number of decorative sheets 31 included in the decorative structure 33 and is fifteen in the case of the decorative structure 33 of Embodiment 2-1 to 2-4.

The method for producing the decorative sheet 31 is a method for producing the decorative sheets 31 in the decorative structure 33 of the embodiment. That is, the decorative sheets 31 have individual patterns 32, one for each of the decorative sheets 31. The plurality of individual patterns 32 indispensably include a plurality of individual patterns 32 having patterns different from each other and optionally include a plurality of individual patterns 32 having patterns identical to each other. The individual patterns 32 include characteristic patterns 321 and non-characteristic patterns 322, The characteristic patterns 321 are individual patterns 32 having characteristic patterns, and The non-characteristic patterns 322 are individual patterns 32 having no characteristic pattern.

The production method of the embodiment includes sequentially coating base materials 313 in the prescribed number while continuously transporting the base materials to provide the base material 313 with the individual patterns 32 on a one-to-one basis. Further, when coating the base materials 313, an order in which the characteristic patterns 321 and the non-characteristic patterns 322 appear has no periodicity.

A main component of the base materials 313 is, for example, a ceramic-based base material made of hardened cement. Note that the materials for the base materials 313 are not limited to this example. Each base material 313 has a plate shape. Each base material 313 preferably has a reception layer as a superficial layer thereof. The reception layer is a layer having a function of improving the fixing properties of ink. The reception layer can be coated by using an ink jet coater or the like after the base material 313 is accordingly treated with primer.

A coating method is not limited to a particular method, but coating by an ink jet method is preferable. In this case, the individual pattern 32 can be easily changed for each decorative sheet 31.

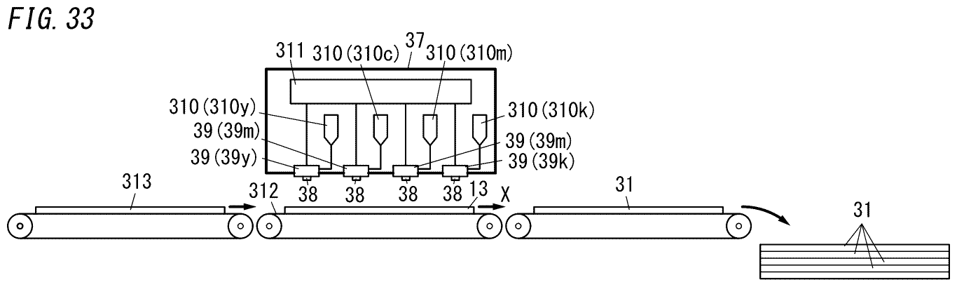

FIG. 33 shows an example of the ink jet coater for imparting the individual pattern 32 to the base material 313.

The ink jet coater includes, for example, coating nozzle heads 39 including respective injection nozzles 38, coating material supplying tanks 310 from which inks, such as aqueous inks or ultraviolet curable inks, are supplied to the respective injection nozzles 38 of the coating nozzle heads 39, and a coating control system 311 configured to control ejection of the inks from the respective injection nozzles 38 of the coating nozzle heads 39.

The coating nozzle heads 39 include four types of coating nozzle heads 39y, 39c, 39m, and 39k configured to respectively eject yellow, cyan, magenta, and black inks. Thus, coating by a full-color printing method is possible. The coating material supplying tanks 310 include coating material supplying tanks 310y, 310c, 310m, and 310k from which inks are supplied respectively to the four types of coating nozzle heads 39y, 39c, 39m, and 39k. That is, the coating material supplying tanks 310 include the coating material supplying tank 310y from which the yellow ink is supplied to the coating nozzle head 39y, the coating material supplying tank 310c from which the cyan ink is supplied to the coating nozzle head 39c, the coating material supplying tank 310m from which the magenta ink is supplied to the coating nozzle head 39m, and the coating material supplying tank 310k from which the black ink is supplied to the coating nozzle head 39k. The coating nozzle heads 39 are arranged along a transportation direction of the base material 313.

The coating control system 311 can include various types of CPU, ROM and RAM, for example. The coating control system 311 includes a data generator, a coating control unit, an injection nozzle control unit, and the like. The data generator stores pieces of image data on the plurality of types of individual patterns 32. The coating control unit sequentially selects a piece of image data on the individual pattern 32 to be printed from the pieces of image data on the plurality of types of individual patterns 32, and based on the piece of image data thus selected, the coating control unit outputs a control signal to the injection nozzle control unit. The injection nozzle control unit controls the injection nozzles 38 on the basis of the control signal received from the coating control unit. Each injection nozzle 38 is operated, for example, by a piezo control method. Controlling each injection nozzle 38 by the injection nozzle control unit individually controls injection and stop of each of the yellow, cyan, magenta, and black inks. Thus, the base material 313 is coated to be provided with the individual pattern 32 corresponding to the piece of image data thus selected.

A transportation conveyor 312 for transporting the base material 313 is disposed below an ink jet coater 37. The transportation conveyor 312 transports the base material 313 in one direction at a fixed speed. The transportation conveyor 312 is, for example, a belt conveyor.

To provide the base materials 313 with coatings, the transportation conveyor 312 sequentially transports a prescribed number of base materials 313. The base materials 313 are sequentially transported to a location under the ink jet coater 37.

To produce the decorative sheets 31, the prescribed number of base materials 313 are sequentially supplied to a starting end of the transportation conveyor 312. The prescribed number of base materials 313 are sequentially transported by the transportation conveyor 312. The ink jet coater 37 sequentially coats the base materials 313 transported to the location under the ink jet coater 37 by an ink jet method. Thus, imparting respective individual patterns 32 to the base materials 313 produces the decorative sheets 31.

In coating the base materials 313, the coating control unit sequentially selects pieces of image data on the individual patterns 32 such that the order in which the characteristic patterns 321 and the non-characteristic patterns 322 appear has no periodicity. In this case, the coating control unit may sequentially select pieces of image data on the individual patterns 32 in a predetermined order or may generate the order of the individual patterns 32 in accordance with a program such that the order in which the characteristic patterns 321 and the non-characteristic patterns 322 appear has no periodicity, and based on a result of the generation, the coating control unit may sequentially select pieces of image data on the individual patterns 32.

The decorative sheets 31 thus produced are further transported by the transportation conveyor 312 and are stacked at a terminating end of the transportation conveyor 312 in the order in which the decorative sheets 31 are transported. The decorative sheet set of the embodiment is thus obtained.

Note that the coating method in the embodiments is the ink jet method as described above, but this should not be construed as limiting. Any general appropriate coating method may be employed.

### Summary

A decorative sheet set 1 according to a first aspect includes a plurality of decorative sheets 11 to 16, and the plurality of decorative sheets 11 to 16 have appearance designs different from one another. A variation in the appearance designs among the plurality of decorative sheets 11 to 16 is within a predetermined range.

This aspect provides the advantage that randomly installing two or more types of decorative sheets 11 to 16 selected from the decorative sheets 11 to 16 can form a decorative structure 10 which makes an impression of reduced incongruity. This aspect further provides the advantage that the way the decorative sheets 11 to 16 are arranged can create variations in a decorative surface.

In a second aspect referring to the first aspect, the plurality of decorative sheets 11 to 16 have surfaces having design regions having a common design among the plurality of decorative sheets 11 to 16. At least one of a proportion, location, or color of the design regions in the surface of each of the plurality of decorative sheets 11 to 16 is different among the plurality of decorative sheets 11 to 16. A difference between a proportion of an area of the design regions in one decorative sheet arbitrarily selected from the plurality of decorative sheets 11 to 16 to an area of the surface of the one decorative sheet and a proportion of a sum of areas of the design regions of the plurality of decorative sheets 11 to 16 to a sum of areas of the surfaces of the plurality of decorative sheets 11 to 16 is within a predetermined range.

This aspect provides the advantage that randomly installing two or more types of decorative sheets 11 to 16 selected from the decorative sheets 11 to 16 can form a decorative structure 10 which makes an impression of reduced incongruity. This aspect further provides the advantage that the way the decorative sheets 11 to 16 are arranged can create variations in a decorative surface.

In a third aspect referring to the second aspect, the design regions are colored parts provided with colors. A color difference ΔE₁ between the colored parts of two decorative sheets arbitrarily selected from the plurality of decorative sheets 11 to 16 is within a predetermined range.

In a fourth aspect referring to the second or third aspect, the difference between the proportion of the area of the design regions in the one decorative sheet arbitrarily selected from the plurality of decorative sheets 11 to 16 to the area of the surface of the one decorative sheet and the proportion of the sum of the areas of the design regions of the plurality of decorative sheets 11 to 16 to the sum of the areas of the surfaces of the plurality of decorative sheets 11 to 16 is greater than or equal to 0% points and less than or equal to 20% points.

This aspect provides the advantage that randomly installing two or more types of decorative sheets 11 to 16 selected from the decorative sheets 11 to 16 can form a decorative structure which makes an impression of reduced incongruity. This aspect further provides the advantage that the way the decorative sheets 11 to 16 are arranged can create variations in a decorative surface.

In a fifth aspect referring to any one of the first to fourth aspects, each of the plurality of decorative sheets 11 to 16 has, as the design regions, a plurality of colored parts having colors different from each other. The color of each of the plurality of colored parts is common to the plurality of decorative sheets. A proportion of an area of at least one colored part of the plurality of colored parts is different among the plurality of decorative sheets 11 to 16.

This aspect provides the advantage that an appearance common to the decorative sheets 11 to 16 can be shown, and randomly installing two or more types of decorative sheets 11 to 16 selected from the decorative sheets 11 to 16 can form a decorative structure 10 which makes an impression of reduced incongruity. This aspect further provides the advantage that the way the decorative sheets 11 to 16 are arranged can create variations in a decorative surface.

In a sixth aspect referring to the fifth aspect, a proportion of a total area of the plurality of colored parts 21 to 23 to each of the decorative sheets 11 to 16 is higher than or equal to 40% of the area of the surface of a corresponding one of the plurality of decorative sheets 11 to 16.

In this aspect, the parts colored with common colors occupy higher than or equal to 40% of each of the decorative sheets 11 to 16, and therefore, this aspect provides the advantage that an appearance common to the decorative sheets 11 to 16 can be shown and randomly installing two or more types of decorative sheets 11 to 16 selected from the decorative sheets 11 to 16 can form a decorative structure 10 which makes an impression of reduced incongruity. This aspect further provides the advantage that the way the decorative sheets 11 to 16 are arranged can create variations in a decorative surface.

In a seventh aspect referring to the fifth or sixth aspect, when each of the plurality of decorative sheets 11 to 16 is divided into four portions identical to one another in terms of shape and area, a proportion of a total area of the colored parts 21 to 23 in each of the portions to an area of a corresponding one of the portions is higher than or equal to 40%.

In this aspect, the parts colored with the common colors occupy higher than or equal to 40% of each of the portions obtained by dividing each of the decorative sheets 11 to 16, and thus, this aspect has the advantage that the decorative sheets 11 to 16 can show an overall common appearance without the parts colored with the common colors being unequally distributed in each of the decorative sheets 11 to 16, randomly installing two or more types of decorative sheets 11 to 16 selected from the decorative sheets 11 to 16 can form a decorative structure 10 which makes an impression of further reduced incongruity. This aspect further provides the advantage that the way the decorative sheets 11 to 16 are arranged can create variations in a decorative surface.

In an eighth aspect referring to any one of the first to seventh aspects, the plurality of decorative sheets 11 to 16 each have a non-exposed part which is not exposed outside when he plurality of decorative sheets 11 to 16 are installed, and the non-exposed part is provided with an identification mark.

In this aspect, the types of decorative sheets 11 to 16 can be identified also when the types of decorative sheets 11 to 16 have similar appearances, and therefore, this aspect provides the advantage that the decorative sheets 11 to 16 can be easily installed.

In a ninth aspect referring to any one of the first to eighth aspects, each of the appearance designs of the plurality of decorative sheets 11 to 16 includes a color, or a combination of the color and recesses and projections.

This aspect enables the decorative sheets 11 to 16 to have different appearance designs for each of the decorative sheets 11 to 16 at least by the color. Moreover, this aspect provides the advantage that randomly installing two or more types of decorative sheets 11 to 16 selected from the decorative sheets 11 to 16 can form a decorative structure 10 which makes an impression of reduced incongruity, and the decorative structure 10 which configures a decorative surface of a building such that the decorative surface making a harmonious impression is easily obtained.

In a tenth aspect referring to any one of the first to ninth aspects, the variation in the appearance designs is defined by a color difference ΔE_{1(MAX)} between an average color value in a decorative sheet which is included in the plurality of decorative sheets 11 to 16 and whose average color value of the appearance design is highest and an average color value of a decorative sheet which is included in the plurality of decorative sheets 11 to 16 and whose average color value of the appearance design is lowest, and the predetermined range is less than or equal to 8.0.

This aspect provides the advantage that randomly installing two or more types of decorative sheets 11 to 16 selected from the decorative sheets 11 to 16 can form a decorative structure which makes an impression of reduced incongruity, and the decorative structure 10 which configures a decorative surface of a building such that the decorative surface making a harmonious impression is easily obtained.

In an eleventh aspect referring to the tenth aspect, the decorative sheet set satisfies a relationship expressed as: ΔE_{1(MAX)}≤ΔE_{2(MAX)}, where ΔE_{2(MAX)} is a maximum value of values ΔE₂ in the plurality of decorative sheets 11 to 16, each of the values ΔE₂ is a maximum value of a color difference of an average color value between two blocks arbitrarily selected from a plurality of blocks obtained by equally dividing a corresponding one of the plurality of decorative sheets 11 to 16 along virtual edges.

This aspect provides the advantage that randomly installing two or more types of decorative sheets 11 to 16 selected from the decorative sheets 11 to 16 can form a decorative structure which makes an impression of reduced incongruity, and the decorative structure 10 which configures a decorative surface of a building such that the decorative surface making a harmonious impression is easily obtained.

In a twelfth aspect referring to the eleventh aspect, each of the values ΔE₂ of the color difference is greater than or equal to 1.2 and less than 10.0.

This aspect provides the advantage that randomly installing two or more types of decorative sheets 11 to 16 selected from the decorative sheets 11 to 16 can form a decorative structure which makes an impression of reduced incongruity, and the decorative structure 10 which configures a decorative surface of a building such that the decorative surface making a harmonious impression is easily obtained.

A decorative structure 10 of a thirteenth aspect is a decorative structure 10 including the plurality of decorative sheets included in the decorative sheet set of the eleventh or twelfth aspect including one or more decorative sheet sets. the ΔE₂ in each of two adjacent decorative sheets arbitrarily selected from the plurality of decorative sheets and a color difference ΔE₃ of an average color value between two blocks which are each included in a corresponding one of the two decorative sheets and which are adjacent to each other have a relationship expressed as: ΔE₃≤ΔE₂.

This aspect provides the advantage that randomly installing two or more types of decorative sheets 11 to 16 selected from the decorative sheets 11 to 16 can form a decorative structure 10 which makes an impression of reduced incongruity, and the decorative structure 10 which configures a decorative surface of a building such that the decorative surface making a harmonious impression is easily obtained.

In a fourteenth aspect referring to any one of the first to eighth aspects, each of the appearance designs of the plurality of decorative sheets 11 to 16 includes recesses and projections, or a combination of the recesses and projections and a color.

This aspect enables the decorative sheets 11 to 16 to have different appearance designs for each of the decorative sheets 11 to 16 at least by the recesses and projections. Moreover, this aspect provides the advantage that randomly installing two or more types of decorative sheets 11 to 16 selected from the decorative sheets 11 to 16 can form a decorative structure 10 which makes an impression of reduced incongruity, and the decorative structure 10 which configures a decorative surface of a building such that the decorative surface making a harmonious impression is easily obtained.

In a fifteenth aspect referring to the fourteenth aspect, a variation in the appearance design is defined by a multiplying factor ΔT_{1(MAX)} of a projection ratio in a decorative sheet which is included in the plurality of decorative sheets 11 to 16 and whose projection ratio of the appearance design is highest to a value of a projection ratio in a decorative sheet which is included in the plurality of decorative sheets 11 to 16 and whose projection ratio of the appearance design is lowest, and the predetermined range is less than or equal to 2.

This aspect provides the advantage that randomly installing two or more types of decorative sheets 11 to 16 selected from the decorative sheets 11 to 16 can form a decorative structure which makes an impression of reduced incongruity, and the decorative structure 10 which configures a decorative surface of a building such that the decorative surface making a harmonious impression is easily obtained.

In a sixteenth aspect referring to the fifteenth aspect, the decorative sheet set satisfies a relationship expressed as: ΔT_{1(MAX)}≤ΔT_{2(MAX)}, where ΔT_{2(MAX)} is a maximum value of values ΔT₂ in the plurality of decorative sheets 11 to 16 each of the values ΔT₂ is a maximum value of a multiplying factor of a high projection ratio to a low projection ratio between two blocks arbitrarily selected from a plurality of blocks obtained by equally dividing a corresponding one of the plurality of decorative sheets 11 to 16 along virtual edges.

This aspect provides the advantage that randomly installing two or more types of decorative sheets 11 to 16 selected from the decorative sheets 11 to 16 can form a decorative structure 10 which makes an impression of reduced incongruity, and the decorative structure 10 which configures a decorative surface of a building such that the decorative surface making a harmonious impression is easily obtained.

In a seventeenth aspect referring to the sixteenth aspect, each of the values ΔT₂ of the multiplying factor is greater than or equal to 1 and less than or equal to 3.

This aspect provides the advantage that randomly installing two or more types of decorative sheets 11 to 16 selected from the decorative sheets 11 to 16 can form a decorative structure 10 which makes an impression of reduced incongruity, and the decorative structure 10 which configures a decorative surface of a building such that the decorative surface making a harmonious impression is easily obtained.

A decorative structure 10 of an eighteenth aspect includes the plurality of decorative sheets 11 to 16 included in the decorative sheet set of the sixteenth or seventeenth aspect including one or more decorative sheet sets. The values ΔT₂ in each of two decorative sheets adjacent to each other and arbitrarily selected from the plurality of decorative sheets 11 to 16 and a multiplying factor ΔT₃ between a high projection ratio to a low projection ratio between the two blocks which are each included in a corresponding one of the two decorative sheets and which are adjacent to each other have a relationship expressed as: ΔT₃≤ΔT₂.

This aspect provides the advantage that randomly installing two or more types of decorative sheets 11 to 18 selected from the decorative sheets 11 to 18 can form a decorative structure 10 which makes an impression of reduced incongruity. The decorative structure 10 which configures a decorative surface of a building such that the decorative surface making a harmonious impression is easily obtained.

A decorative structure 10 of nineteenth aspect includes the plurality of decorative sheets 11 to 16 included in the decorative sheet set of any one of the first to twelfth aspects and the fourteenth to seventeenth aspects including one or more decorative sheet sets.

This aspect provides the advantage that randomly installing two or more types of decorative sheets 11 to 16 selected from the decorative sheets 11 to 16 can form a decorative structure 10 which makes an impression of reduced incongruity, and the decorative structure 10 which configures a decorative surface of a building such that the decorative surface making a harmonious impression is easily obtained.

In a twentieth aspect referring to the nineteenth aspect, the plurality of decorative sheets having the appearance designs identical to each other are not arranged three or more in succession.

In this aspect, decorative sheets 11 to 16 having identical appearance designs are not arranged three or more in succession, and most of the decorative sheets 11 to 16 having identical appearance designs of the decorative sheets 11 to 16 are arranged separate from each other. Therefore, this aspect enables the decorative structure 10 to be provided with an appearance design which is random and which gives an impression of full of originality. Meanwhile, the decorative structure 10 includes the decorative sheets 11 to 16, and therefore, this aspect provides the advantage that the decorative structure 10 which configures a decorative surface of a building such that the decorative surface making a harmonious impression is easily obtained d.

A method for configuring the decorative structure 10 of a twenty-first aspect is a method for constructing a decorative structure 10 by using the decorative sheet set of any one of the first to twelfth aspects and the fourteenth to seventeenth aspects including one or more decorative sheet sets. The method includes a step of determining disposition locations of the plurality of decorative sheets 11 to 16 included in the one or more decorative sheet sets 1 on an installation target surface, and a step of installing the plurality of decorative sheets 11 to 16 on the disposition locations thus determined.

This aspect provides the advantage that a decorative structure 10 which configures a decorative surface of a building such that the decorative surface making a harmonious impression is easily obtained.

A method for configuring the decorative structure 10 of a twenty-second aspect is a method for constructing a decorative structure 10 by using the decorative sheet set of any one of the first to twelfth aspects and the fourteenth to seventeenth aspects including one or more decorative sheet sets. The method includes a step of registering a drawing of a building having the installation target surface at a computer, a step of determining disposition locations of the plurality of decorative sheets 11 to 16 on the installation target surface on a screen of the computer by a simulation, a step of displaying the disposition locations thus determined on the drawing, and a step of installing the plurality of decorative sheets of the one or more decorative sheet sets in accordance with the drawing showing the disposition locations.

This aspect provides the advantage that a decorative structure 10 assumed by the simulation in advance can be formed, and the decorative structure 10 which configures a decorative surface of a building such that the decorative surface making a harmonious impression is easily obtained.

In a twenty-third aspect referring to the twenty-first or twenty-second aspect, the method further includes a step of loading and packing the plurality of decorative sheets 11 to 16 of the decorative sheet set 1 in an order according to the disposition locations thus determined.

This aspect provides the advantage that time and effort in sorting the plurality of decorative sheets 11 to 16 can be saved at the time of installation, and the decorative structure 10 which configures a decorative surface of a building such that the decorative surface making a harmonious impression is easily obtained.

A decorative structure 33 of a twenty-fourth aspect has a decorative surface 331. The decorative surface 331 has an overall pattern 320 which is a collection of a plurality of individual patterns 32 arranged in one direction along the decorative surface 331. The plurality of individual patterns 32 indispensably include a plurality of individual patterns 32 having patterns different from each other and optionally include a plurality of individual patterns 32 having patterns identical to each other. The plurality of individual patterns 32 include characteristic patterns 321 and non-characteristic patterns 322. The characteristic patterns 321 are individual patterns 32 having characteristic patterns. The non-characteristic patterns 322 are individual patterns 32 having no characteristic pattern. An order in which the characteristic patterns 321 and the non-characteristic patterns 322 appear in the one direction in the decorative surface 331 has no periodicity.

This aspect reduces unnaturalness in the appearance of the decorative surface 331 also when the decorative surface 331 has a plurality of patterns arranged in one direction, thereby improving the design property of the decorative surface 331.

In a twenty-fifth aspect referring to the twenty-fourth aspect, two arbitrarily selected adjacent individual patterns 32 of the plurality of individual patterns 32 have patterns different from each other.

This aspect further reduces unnaturalness of the appearance of the decorative surface 331.

In a twenty-sixth aspect referring to the twenty-fourth or twenty-fifth aspect, a proportion of a total number of the non-characteristic patterns 322 to a total number of the plurality of individual patterns 32 aligned in the one direction is higher than or equal to 50%.

This aspect further reduces unnaturalness of the appearance of the decorative surface 331.

In a twenty-seventh aspect referring to any one of the twenty-fourth to twenty-sixth aspects, each of the plurality of individual patterns 32 is a color pattern, a maximum color difference between colors making up each of the characteristic patterns 321 is greater than 10, and a maximum color difference between colors making up each of the non-characteristic patterns 322 is less than or equal to 10.

This aspect further reduces unnaturalness of the appearance of the decorative surface 331.

In a twenty-eighth aspect referring to any one of the twenty-fourth to twenty-seventh aspects, a total number of the plurality of individual patterns 32 aligned in the one direction is greater than or equal to 6.

This aspect further reduces unnaturalness of the appearance of the decorative surface 331.

In a twenty-ninth aspect referring to any one of the twenty-fourth to twenty-eighth aspects, the plurality of individual patterns 32 at least include four or more types of individual patterns 32 having patterns different from one another.

This aspect further reduces unnaturalness of the appearance of the decorative surface 331.

In a thirtieth aspect referring to any one of the twenty-fourth to twenty-ninth aspects, in the overall pattern 320, the characteristic patterns 321 do not appear four or more in succession and the non-characteristic patterns 322 do not appear three or more in succession in the one direction.

This aspect further reduces unnaturalness of the appearance of the decorative surface 331.

In a thirty-first aspect referring to any one of the twenty-fourth to thirtieth aspects, the plurality of individual patterns 32 have outer perimeters identical to each other in terms of shape and size.

This aspect further reduces unnaturalness of the appearance of the decorative surface 331.

In a thirty-second aspect referring to any one of the twenty-fourth to thirty-first aspects, the decorative structure 33 includes a plurality of decorative sheets 31 aligned in the one direction. The plurality of decorative sheets 31 have the plurality of individual patterns 32, one for each of the plurality of decorative sheets 31.

This aspect further reduces unnaturalness of the appearance of the decorative surface 331.

A decorative sheet set of a thirty-third aspect includes a plurality of decorative sheets 31 stacked one on top of another. The plurality of decorative sheets have individual patterns 32, one for each of the plurality of decorative sheets 31, The individual patterns 32 indispensably includes a plurality of individual patterns 32 having patterns different from each other and optionally includes a plurality of individual patterns 32 having patterns identical to each other. The individual patterns 32 includes characteristic patterns 321 and non-characteristic patterns 322. The characteristic patterns 321 are individual patterns 32 having characteristic patterns. The non-characteristic patterns 322 are individual patterns 32 having no characteristic pattern. An order in which the characteristic patterns 321 and the non-characteristic patterns 322 appear in a direction in which the plurality of decorative sheets 31 are stacked one on top of another has no periodicity.

A method for producing a decorative sheet 31 of a thirty-fourth aspect is a method for sequentially producing a prescribed number of decorative sheets 31. The decorative sheets 31 have individual patterns 32, one for each of the decorative sheets 31. The individual patterns 32 indispensably include a plurality of individual patterns 32 having patterns different from each other and optionally include a plurality of individual patterns 32 having patterns identical to each other. The individual patterns 32 include characteristic patterns 321 and non-characteristic patterns 322. The characteristic patterns 321 are individual patterns 32 having characteristic patterns. The non-characteristic patterns 322 are individual patterns 32 having no characteristic pattern. The method includes sequentially coating base materials 313 prepared in the prescribed number while continuously transporting the base materials 313 to provide the base materials 313 with the individual patterns 32 on a one-to-one basis. In coating the base materials 313, an order in which the characteristic patterns 321 and the non-characteristic patterns 322 appear has no periodicity.

1. A decorative sheet set comprising a plurality of decorative sheets,
the plurality of decorative sheets having appearance designs different from each other,
a variation in the appearance designs between the plurality of decorative sheets being within a predetermined range.

2. The decorative sheet set of claim 1, wherein
the plurality of decorative sheets have surfaces having design regions having a common design between the plurality of decorative sheets,
at least one of a proportion, location, or color of the design regions in the surface of each of the plurality of decorative sheets is different between the plurality of decorative sheets, and
a difference between a proportion of an area of the design regions in one decorative sheet arbitrarily selected from the plurality of decorative sheets to an area of the surface of the one decorative sheet and a proportion of a sum of areas of the design regions of the plurality of decorative sheets to a sum of areas of the surfaces of the plurality of decorative sheets is within a predetermined range.

3. The decorative sheet set of claim 2, wherein
the design regions are colored parts provided with colors, and
a color difference ΔE₁ between the colored parts of two decorative sheets arbitrarily selected from the plurality of decorative sheets is within a predetermined range.

4. The decorative sheet set of claim 2, wherein
the difference between the proportion of the area of the design regions in the one decorative sheet arbitrarily selected from the plurality of decorative sheets to the area of the surface of the one decorative sheet and the proportion of the sum of the areas of the design regions of the plurality of decorative sheets to the sum of the areas of the surfaces of the plurality of decorative sheets is greater than or equal to 0% points and less than or equal to 20% points.

5. The decorative sheet set of claim 2, wherein
each of the plurality of decorative sheets has, as the design regions, a plurality of colored parts having colors different from each other,
the color of each of the plurality of colored parts is common to the plurality of decorative sheets, and
a proportion of an area of at least one colored part of the plurality of colored parts is different between the plurality of decorative sheets.

6. The decorative sheet set of claim 5, wherein
a proportion of a total area of the plurality of colored parts to each of the plurality of decorative sheets is higher than or equal to 40% of the area of the surface of a corresponding one of the plurality of decorative sheets.

7. The decorative sheet set of claim 5, wherein
when each of the plurality of decorative sheets is divided into four portions identical to one other in terms of shape and area, a proportion of a total area of the colored parts in each of the portions to an area of a corresponding one of the portions is higher than or equal to 40%.

8. The decorative sheet set of claim 1, wherein
the plurality of decorative sheets each have a non-exposed part which is not exposed outside when the plurality of decorative sheets are installed, and
the non-exposed part is provided with an identification mark.

9. The decorative sheet set of claim 1, wherein
each of the appearance designs of the plurality of decorative sheets includes a color, or a combination of the color and recesses and projections.

10. The decorative sheet set of claim 9, wherein
the variation in the appearance designs is defined by a color difference ΔE_{1(MAX)} between an average color value in a decorative sheet which is included in the plurality of decorative sheets and whose average color value of the appearance design is highest and an average color value of a decorative sheet which is included in the plurality of decorative sheets and whose average color value of the appearance design is lowest, and the predetermined range is less than or equal to 8.0.

11. The decorative sheet set of claim 10, wherein
the decorative sheet set satisfies a relationship expressed as: ΔE_{1(MAX)}≤ΔE_{2(MAX)}, where ΔE_{2(MAX)} is a maximum value of values ΔE₂ in the plurality of decorative sheets, each of the values ΔE₂ is a maximum value of a color difference of an average color value between two blocks arbitrarily selected from a plurality of blocks obtained by equally dividing a corresponding one of the plurality of decorative sheets along virtual edges.

12. The decorative sheet set of claim 11, wherein
each of the values ΔE₂ of the color difference is greater than or equal to 1.2 and less than

10. 0.

13. A decorative structure comprising the plurality of decorative sheets included in the decorative sheet set of claim 11 including one or more decorative sheet sets,
the value ΔE₂ in each of two decorative sheets adjacent to each other and arbitrarily selected from the plurality of decorative sheets and a color difference ΔE₃ of an average color value between two blocks which are each included in a corresponding one of the two decorative sheets and which are adjacent to each other having a relationship expressed as: ΔE₃≤ΔE₂.

14. The decorative sheet set of claim 1, wherein
each of the appearance designs of the plurality of decorative sheets includes recesses and projections, or a combination of the recesses and projections and a color.

15. The decorative sheet set of claim 14, wherein
a variation in the appearance designs is defined by a multiplying factor ΔT_{1(MAX)} of a projection ratio in a decorative sheet which is included in the plurality of decorative sheets and whose projection ratio of the appearance design is highest to a value of a projection ratio in a decorative sheet which is included in the plurality of decorative sheets and whose projection ratio of the appearance design is lowest, and
the predetermined range is less than or equal to 2.

16. The decorative sheet set of claim 15, wherein
the decorative sheet set satisfies a relationship expressed as: ΔT_{1(MAX)}≤ΔT_{2(MAX)}, where ΔT_{2(MAX)} is a maximum value of values ΔT₂ in the plurality of decorative sheets, each of the values ΔT₂ is a maximum value of a multiplying factor of a high projection ratio to a low projection ratio between two blocks arbitrarily selected from a plurality of blocks obtained by equally dividing a corresponding one of the plurality of decorative sheets along virtual edges.

17. The decorative sheet set of claim 16, wherein
each of the values ΔT₂ of the multiplying factor is greater than or equal to 1 and less than or equal to 3.

18. A decorative structure comprising the plurality of decorative sheets included in the decorative sheet set of claim 16 including one or more decorative sheet sets,
the value ΔT₂ in each of two decorative sheets adjacent to each other and arbitrarily selected from the plurality of decorative sheets and a multiplying factor ΔT₃ between a high projection ratio to a low projection ratio between the two blocks which are each included in a corresponding one of the two decorative sheets and which are adjacent to each other having a relationship expressed as: ΔT₃≤ΔT₂.

19. A decorative structure comprising the plurality of decorative sheets included in the decorative sheet set of claim 1 including one or more decorative sheet sets.

20. The decorative structure of claim 19, wherein
the plurality of decorative sheets having the appearance designs identical to each other are not arranged three or more in succession.

21. A method for constructing a decorative structure by using the decorative sheet set of claim 1 including one or more decorative sheet sets, the method comprising:
a step of determining disposition locations of the plurality of decorative sheets included in the one or more decorative sheet sets on an installation target surface; and
a step of installing the plurality of decorative sheets on the disposition locations thus determined.

22. A method for constructing a decorative structure by using the decorative sheet set of claim 1 including one or more decorative sheet sets, the method comprising:
a step of registering a drawing of a building having the installation target surface at a computer;
a step of determining disposition locations of the plurality of decorative sheets on the installation target surface on a screen of the computer by a simulation;
a step of displaying the disposition locations thus determined on the drawing; and
a step of installing the plurality of decorative sheets of the one or more decorative sheet sets in accordance with the drawing showing the disposition locations.

23. The method of claim 21 further comprising a step of loading and packing the plurality of decorative sheets of the one or more decorative sheet sets in an order according to the disposition locations thus determined.

24. A decorative structure comprising a decorative surface,
the decorative surface having an overall pattern which is a collection of a plurality of individual patterns arranged in one direction along the decorative surface, the plurality of individual patterns indispensably including a plurality of individual patterns having patterns different from each other and optionally including a plurality of individual patterns having patterns identical to each other,
the plurality of individual patterns including characteristic patterns and non-characteristic patterns,
the characteristic patterns being individual patterns having characteristic patterns,
the non-characteristic patterns being individual patterns having no characteristic pattern,
an order in which the characteristic patterns and the non-characteristic patterns appear in the one direction in the decorative surface having no periodicity.

25. The decorative structure of claim 24, wherein
two arbitrarily selected adjacent individual patterns of the plurality of individual patterns have patterns different from each other.

26. The decorative structure of claim 24, wherein
a proportion of a total number of the non-characteristic patterns to a total number of the plurality of individual patterns aligned in the one direction is higher than or equal to 50%.

27. The decorative structure of claim 24, wherein
each of the plurality of individual patterns is a color pattern,
a maximum color difference between colors making up each of the characteristic patterns is greater than 10, and
a maximum color difference between colors making up each of the non-characteristic patterns is less than or equal to 10.

28. The decorative structure of claim 24, wherein
a total number of the plurality of individual patterns aligned in the one direction is greater than or equal to 6.

29. The decorative structure of claim 24, wherein
the plurality of individual patterns at least include four or more types of individual patterns having patterns different from each other.

30. The decorative structure of claim 24, wherein
in the overall pattern, the characteristic patterns do not appear four or more in succession and the non-characteristic patterns do not appear three or more in succession in the one direction.

31. The decorative structure of claim 24, wherein
the plurality of individual patterns have outer perimeters identical to each other in terms of shape and size.

32. The decorative structure of claim 24, wherein
the decorative structure includes a plurality of decorative sheets aligned in the one direction, and
the plurality of decorative sheets have the plurality of individual patterns, one for each of the plurality of decorative sheets.

33. A decorative sheet set comprising a plurality of decorative sheets stacked one on top of another,
the plurality of decorative sheets having individual patterns, one for each of the plurality of decorative sheets,
the individual patterns indispensably including a plurality of individual patterns having patterns different from each other and optionally including a plurality of individual patterns having patterns identical to each other,
the individual patterns including characteristic patterns and non-characteristic patterns,
the characteristic patterns being individual patterns having characteristic patterns,
the non-characteristic patterns being individual patterns having no characteristic pattern,
an order in which the characteristic patterns and the non-characteristic patterns appear in a direction in which the plurality of decorative sheets are stacked one on top of another having no periodicity.

34. A method for producing a decorative sheet being a method for sequentially producing a prescribed number of decorative sheets,
the decorative sheets having individual patterns, one for each of the decorative sheets,
the individual patterns indispensably including a plurality of individual patterns having patterns different from each other and optionally including a plurality of individual patterns having the same pattern,
the individual patterns including characteristic patterns and non-characteristic patterns,
the characteristic patterns being individual patterns having characteristic patterns,
the non-characteristic patterns being individual patterns having no characteristic pattern,
the method comprising sequentially coating base materials prepared in the prescribed number while continuously transporting the base materials to provide the base materials with the individual patterns on a one-to-one basis,
in coating the base materials, an order in which the characteristic patterns and the non-characteristic patterns appear having no periodicity.
